(19) United States
(12) Patent Application Publication
(10) Pub. No.: US 2011/0128355 A1
(43) Pub. Date: Jun. 2, 2011

(54) IMAGE PROCESSING APPARATUS AND IMAGE PROCESSING METHOD

(75) Inventors: Teruhiko Suzuki, Kanagawa (JP); Yoshitomo Takahashi, Kanagawa (JP); Takuya Kitamura, Tokyo (JP)

(73) Assignee: Sony Corporation, Tokyo (JP)

(21) Appl. No.: 12/953,540

(22) Filed: Nov. 24, 2010

(30) Foreign Application Priority Data
Dec. 2, 2009 (JP) 2009-274538

(51) Int. Cl. H04N 13/02

(52) U.S. Cl. 348/50; 348/E13.074

(57) ABSTRACT

An image processing apparatus includes: a coding means for encoding image data of multi-view images forming a stereoscopic image to generate a coded stream; and a transmission means for connecting output time information indicating output time of a decoded result of an image only to coded data of any one of the multi-view images in the coded stream.

### BACKGROUND OF THE INVENTION

1. Field of the Invention

The present invention relates to an image processing apparatus and an image processing method, and particularly related to an image processing apparatus and an image processing method capable of recognizing pairs of multi-view images at the time of decoding when multi-view images forming a stereoscopic image are multiplexed and encoded.

2. Description of the Related Art

In recent years, apparatuses complying with MPEG (Moving Picture Expert Group) methods and the like are becoming popular both in information delivery at broadcasting stations and so on and in information reception at home, in which image information is treated as digital signals and is compressed by orthogonal transformation such as discrete cosine transform and motion compensation using redundancy peculiar to image information for the purpose of transmitting and accumulating information efficiently.

That is, an coder and a decoder are becoming popular, which are used when receiving image information (bit stream) compressed by coding methods applying orthogonal transformation such as discrete cosine transform or Karhunen-Loeve transform and motion compensation such as MPEG and H.26x through network media such as satellite broadcasting, cable TV and Internet, or when processing the image information on storage media such as optical/magnetic discs and a flash memory.

For example, MPEG2 (ISO/IEC 13818-2) is defined as a general-purpose image coding method, which is a standard covering both interlaced scanning images (images of an interlace method) and progressive scanning images (images of a progressive method) as well as standard definition images and high definition images, and which is widely used at present for extensive applications for professional use and for consumer use. Using MPEG2 compression method realizes a high compression rate and good image quality by allocating the code amount (bit rate) of 4 to 8 Mbps to the interlaced scanning images of the standard definition having, for example, 720×480 pixels in horizontal×vertical directions, and by allocating the bit rate of 18 to 22 Mbps to the interfaced scanning images of the high definition having 1920×1088 pixels.

MPEG2 was aimed at the coding with high image quality chiefly adapted to broadcasting but did not respond to the code amount (bit rate) lower than MPEG1, namely, coding methods with higher compression rate. The needs for such coding methods are anticipated to be increased from now in accordance with the spread of portable terminals, and standardization of MPEG4 coding method was performed so as to respond to the needs. Concerning an image coding method, the standard was approved as an international standard as ISO/IEC 14496-2 in December 1998.

Furthermore, standardization of an AVC (MPEG-4 part 10, ISO/IEC 14496-10, ITU-T H.264) coding method is performed. The standardization is advanced by a group called JVT (Joint Video Team) for achieving standardization of the image coding method between ITU-T and ISO/IEC in cooperation with each other.

The AVC is a hybrid coding method combining motion compensation with discrete cosine transform in the same manner as MPEG2 and MPEG4. In the AVC, it is known that higher coding efficiency can be realized though a great deal of calculation amount is necessary because of coding/decoding as compared with coding methods of related art such as MPEG2 and MPEG4.

As imaging techniques and display techniques of stereoscopic images which can be three-dimensionally viewed are developed in recent years, not only contents of two-dimensional images but also contents of stereoscopic images are considered as contents of images to be coding targets as described above. The coding/decoding method of multi-view images forming the stereoscopic images are described in, for example, JP-A-2008-182669 (Patent Document 1).

An image having the minimum number of viewpoints in the stereoscopic images is a 3D (Dimensional) image (stereo image) in which the number of viewpoints is two. Image data of 3D images includes image data of a left-eye image which is an image observed by a left eye (also referred to as an L (left) image in the following description) and image data of a right-eye image which is an image observed by a right eye (also referred to as an R (Right) image in the following description). To make explanation easier, explanation will be made by using the 3D images with two viewpoints which has the minimum number of viewpoints as an example of the multi-view images forming a stereoscopic image.

### SUMMARY OF THE INVENTION

When coded data of 3D images is a bit stream obtained as a result of multiplexing L images and R images forming the 3D images (referred to as LR pairs in the following description) in the time direction and encoded by the AVC coding method, different DPB (Decoded Picture Buffer) output time information (dpb_output_delay) is added to coded data of the L image and the R image forming the LR pair. The DPB output time information is information of time at which a decoded result is outputted from the DPB.

Accordingly, it is difficult to recognize that coded data of the LR pair is made up of which image coded data and which image coded data in the bit stream by the decoder. Therefore, it is difficult to display the stereoscopic image.

In view of the above, it is desirable that pairs of multi-view images can be recognized at the time of decoding when multi-view images forming the stereoscopic image are multiplexed and encoded.

According to one embodiment of the invention, there is provided an image processing apparatus including a coding means for encoding image data of multi-view images forming a stereoscopic image to generate a coded stream and a transmission means for connecting output time information indicating output time of a decoded result of an image only to coded data of any one of the multi-view images in the coded stream.

An image processing method according to one embodiment of the invention corresponds to the image processing apparatus of the one embodiment of the invention.

In the one embodiment of the invention, image data of multi-view images forming the stereoscopic image is encoded and the coded stream is generated, and the coded stream is transmitted in a state in which output time information indicating output time of the decoded result of the image is connected to coded data of any one of the multi-view images and output time information is not connected to coded data of the image other than the image.

According to another embodiment of the invention, there is provided an image processing apparatus including a receiving means for receiving a coded stream obtained by encoding image data of multi-view images forming a stereoscopic image and output time information indicating output time of a decoded result of an image, which is connected to coded data of any one of the multi-view images in the coded stream, a decoding means for decoding the coded stream received by the receiving means to generate image data and an output means for outputting image data of an image corresponding to the output time information and image data of an image not corresponding to the output time information, which have been generated by the decoding means, as image data of multi-view images based on the output time information received by the receiving means.

An image processing method according to another embodiment of the invention corresponds to the image processing apparatus of another embodiment of the invention.

In another embodiment of the invention, the coded stream obtained by encoding image data of multi-view images forming the stereoscopic image and output time information indicating output time of the decoded result of the image, which is connected to coded data of any one of the multi-view images in the coded stream are received, the received coded stream is decoded to generate image data and image data of the image corresponding to the output time information and image data of the image not corresponding to the output time information which have been generated by decoding are outputted as image data of multi-view images based on the received output time information.

The image processing apparatus according to the embodiments may be an independent apparatus or an internal block which configures one device.

The image processing apparatus according to the embodiments can be realized by allowing a computer to execute programs.

According to the one embodiment of the invention, it is possible to inform the device which decodes the coded stream obtained by multiplexing and coding multi-view images forming the stereoscopic image about pairs of multi-view images to allow the device to recognize pairs of multi-view images.

According to another embodiment of the invention, pairs of multi-view images can be recognized when decoding the coded stream obtained by multiplexing and coding multi-view images forming the stereoscopic image.

### BRIEF DESCRIPTION OF THE DRAWINGS

FIG. 1 is a block diagram showing a configuration example of a coding system to which an embodiment of the invention is applied;

FIG. 2 is a block diagram showing a configuration example of a video coding device of FIG. 1;

FIG. 3 is a diagram for explaining imaging timing in the coding system;

FIG. 4 is a diagram for explaining another imaging timing in the coding system;

FIG. 5 is a diagram for explaining multiplexing by a video synthesis circuit;

FIG. 6 is a block diagram showing a configuration example of a coding circuit of FIG. 2;

FIG. 7 is a diagram for explaining an example of a bit stream;

FIG. 8 is a chart showing an example of syntax of DPB output time information;

FIG. 9 is a flowchart for explaining processing of adding DPB output time information by a reversible coding unit;

FIG. 10 is a block diagram showing another configuration example of a coding system to which another embodiment of the invention is applied;

FIG. 11 is a diagram for explaining a multiplexed signal outputted from a synthesis unit of FIG. 10;

FIG. 12 is a block diagram showing a configuration example of a decoding system;

FIG. 13 is a block diagram showing a configuration example of a video decoding device of FIG. 12;

FIG. 14 is a block diagram showing a configuration example of a decoding circuit of FIG. 13;

FIG. 15 is a flowchart for explaining processing of recognizing LR pairs by an image sorting buffer;

FIG. 16 is a diagram for explaining another example of adding DPB output time information;

FIG. 17 is a block diagram showing a configuration example of a computer according to an embodiment;

FIG. 18 is a block diagram showing a fundamental configuration example of a television receiver to which the embodiment of the invention is applied;

FIG. 19 is a block diagram showing a fundamental configuration example of a cellular phone device to which the embodiment of the invention is applied;

FIG. 20 is a block diagram showing a fundamental configuration example of a hard disk recorder to which the embodiment of the invention is applied; and

FIG. 21 is a block diagram showing a fundamental configuration example of a camera to which the embodiment of the invention is applied.

### DESCRIPTION OF THE PREFERRED EMBODIMENTS

### Embodiment

### [Configuration Example of Coding System According to Embodiment]

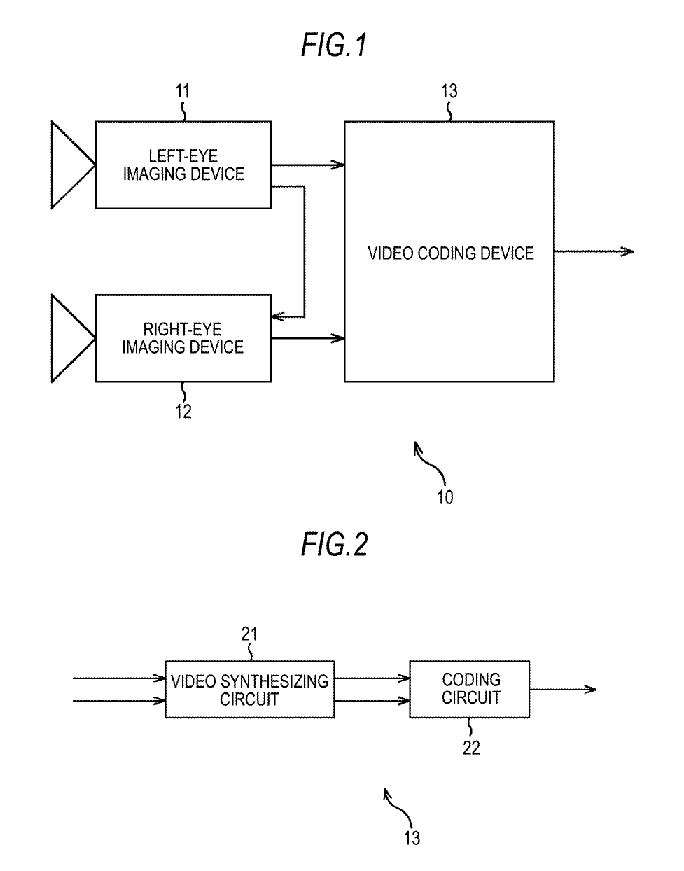

FIG. 1 is a block diagram showing a configuration example of a coding system to which an embodiment of the invention is applied.

A coding system 10 of FIG. 1 includes a left-eye imaging device 11, a right-eye imaging device 12 and a video coding device 13.

The left-eye imaging device 11 is an imaging device for imaging L images and the right-eye imaging device 12 is an imaging device for imaging R images. A synchronization signal is inputted from the left-eye imaging device 11 to the right-eye imaging device 12, and the left-eye imaging device 11 and the right-eye imaging device 12 are synchronized with each other. The left-eye imaging device 11 and the right-eye imaging device 12 perform imaging at predetermined imaging timing.

Image signals of L images imaged by the left-eye imaging device 11 as well as imaging signals of R images imaged by the right-eye imaging device 12 are inputted to the video coding device 13. The video coding device 13 multiplexes the image signals of the L images and the image signals of the R images in pairs of LR in the time direction and performs coding complying with an AVC coding method with respect to a multiplexed signal obtained by the multiplexing. The video coding device 13 outputs a coded stream obtained by the coding as a bit stream.

### [Configuration Example of Vide Coding Device]

FIG. 2 is a block diagram showing a configuration example of the video coding device 13 of FIG. 1.

The video coding device 13 of FIG. 2 includes a video synthesis circuit 21 and a coding circuit 22.

The video synthesis circuit 21 multiplexes image signals of the L images imaged by the left-eye imaging device 11 and image signals of the R images imaged by the right-eye imaging device 12 in the time direction in pairs of LR and supplies the multiplexed signal obtained by the multiplexing to the coding circuit 22.

The coding circuit 22 codes the multiplexed signal inputted from the video synthesis circuit 21 so as to comply with the AVC coding method. At this time, the coding circuit 22 adds DPB output time information to coded data of an image which is previous in the coding order of the LR pair and does not add DPB output time information to coded data of a subsequent image. The coding circuit 22 outputs a coded stream in which the DPB output time information is added to the coded data of images which are previous in the coding order of the LR pairs as a bit stream.

In the following explanation will be made on the premise that the L image is coded first and the R image is subsequently coded in the coded order of LR pairs.

### [Explanation of Imaging Timing]

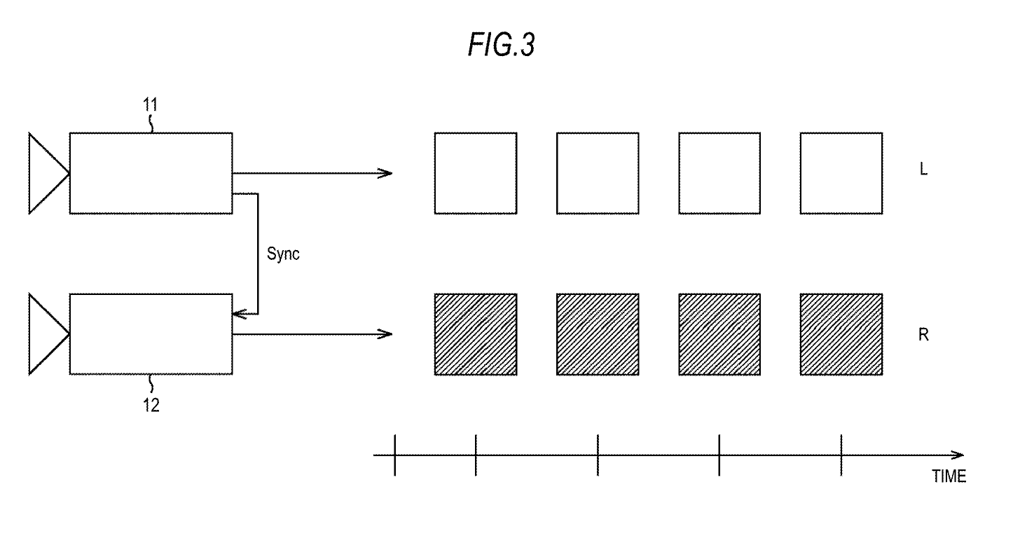

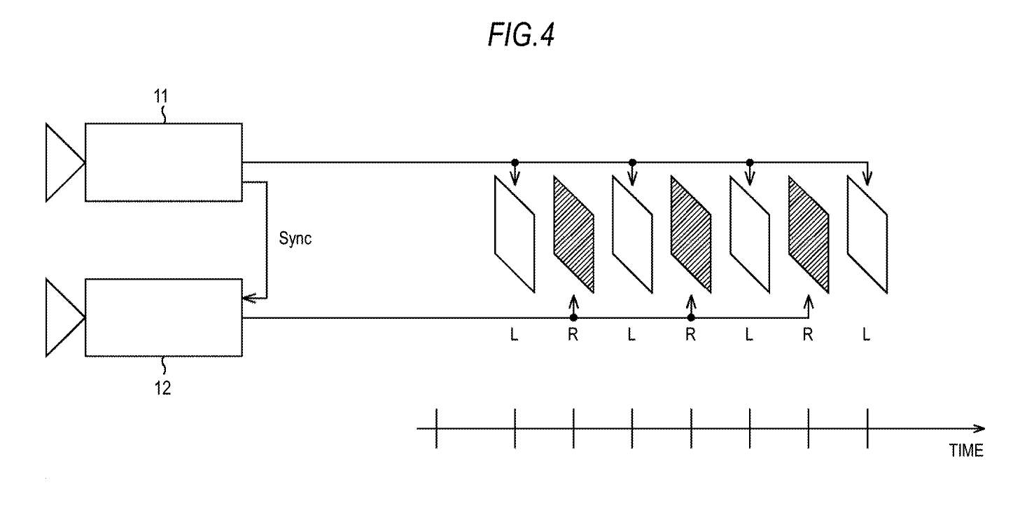

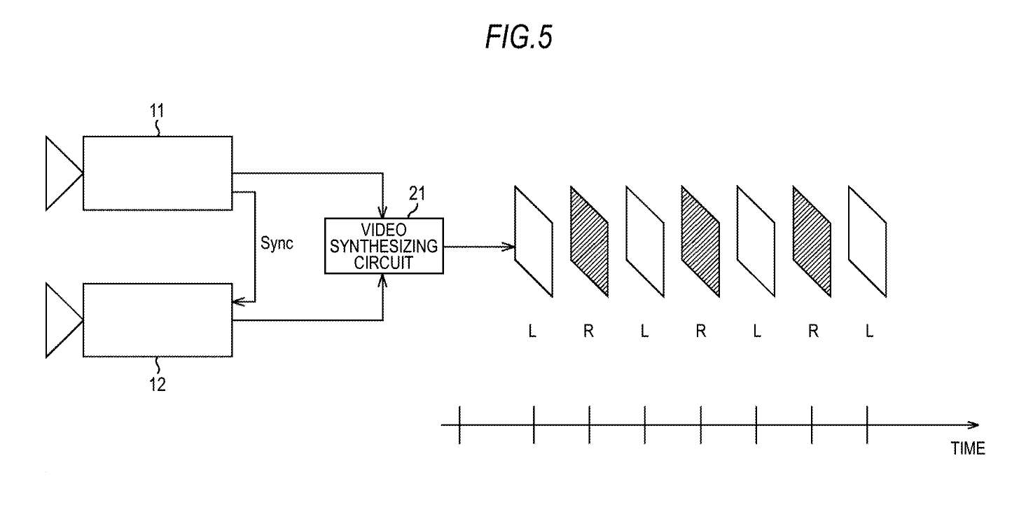

FIG. 3 and FIG. 4 are diagrams for explaining imaging timing in the coding system 10.

In the coding system 10, the left-eye imaging device 11 and the right-eye imaging device 12 perform imaging of LR pairs at the same timing as shown in FIG. 3 or perform imaging of LR pairs at continuous different timings as shown in FIG. 4.

### [Explanation of Multiplexing of L Images and R Images]

FIG. 5 is a diagram for explaining multiplexing by the video synthesis circuit 21.

The image signals of L images and the image signals of R images imaged at the timing explained in FIG. 3 and FIG. 4 are supplied to the video synthesis circuit 21 in parallel. The video synthesis circuit 21 multiplexes image signals of L images and image signals of R images in pairs of LR in the time direction. According to the processing, the multiplexed signal outputted from the video synthesis circuit 21 will be an image signal in which the image signals of the L images and the image signals of the R images are alternately repeated.

### [Configuration Example of Coding Circuit]

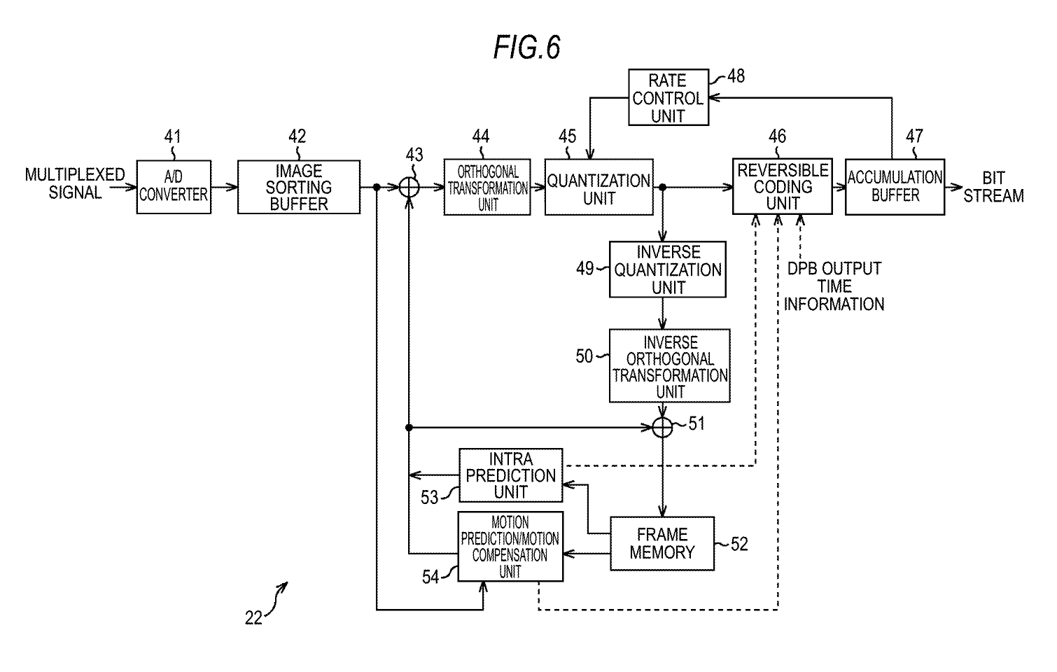

FIG. 6 is a block diagram showing a configuration example of the coding circuit 22 of FIG. 2.

An A/D converter 41 of the coding circuit 22 performs A/D conversion with respect to the multiplexed signal which is an analog signal supplied from the video synthesis circuit 21 to obtain image data which is a digital signal. Then, the A/D converter 41 supplies image data to an image sorting buffer 42.

The image sorting buffer 42 temporarily stores image data from the A/D converter 41 and reads out the data according to need, thereby sorting pictures (frames) of image data (fields) in the coding order in accordance with a GOP (Group of Pictures) structure of the bit stream which is the output of the coding circuit 22.

An intra picture to which intra-coding is performed in pictures read out from the image sorting buffer 42 is supplied to a computing unit 43.

The computing unit 43 subtracts a pixel value of a prediction image supplied from an intra prediction unit 53 from a pixel value of the intra picture supplied from the image sorting buffer 42 if necessary and supplies the value to an orthogonal transformation unit 44.

The orthogonal transformation unit 44 performs orthogonal transformation such as discrete cosine transform or Karhunen-Loeve transform to (the pixel value or subtraction value obtained by subtracting the prediction image of) the intra picture, supplying a transform coefficient obtained as a result of the transformation to a quantization unit 45. The discrete cosine transform performed in the orthogonal transformation unit 44 may be integer transform approximating the discrete cosine transform of actual numbers. As a transform method of the discrete cosine transform, a method of performing integer coefficient transform in the 4×4 block size may be used.

The quantization unit 45 quantizes the transform coefficient from the orthogonal transformation unit 44 and supplies a quantized value obtained as the result of quantization to a reversible coding unit 46.

The reversible coding unit 46 performs reversible coding such as variable-length coding or arithmetic coding to the quantized value from the quantization unit 45 and supplies coded data obtained as a result of the coding to an accumulation buffer 47.

The accumulation buffer 47 temporarily stores coded data from the reversible coding unit 46 and transmits the data as a given bit stream.

A rate control unit 48 monitors the accumulation amount of the coded data in the accumulation buffer 47 and controls behavior of the quantization unit 45 such as quantization steps of the quantization unit 45 based on the accumulation amount.

The quantized value obtained by the quantization unit 45 is supplied not only to the reversible coding unit 46 but also to an inverse quantization unit 49. The inverse quantization unit 49 inversely quantizes the quantized value from the quantization unit 45 to the transform coefficient and supplies data to an inverse orthogonal transformation unit 50.

The inverse orthogonal transformation unit 50 performs inverse orthogonal transformation of the transform coefficient from the inverse quantization unit 49 and supplies the transform coefficient to a computing unit 51.

The computing unit 51 adds the pixel value of the prediction image supplied from the intra prediction unit 53 to the data supplied from the inverse orthogonal transformation unit 50 according to need, thereby obtaining a decoded image of the intra picture to be supplied to a frame memory 52.

The frame memory 52 temporarily stores the decoded image supplied from the computing unit 51 and supplies the decoded image to the intra prediction unit 53 or a motion prediction/motion compensation unit 54 as a reference image used for generating the prediction image according to need.

The intra prediction unit 53 generates the prediction image from pixels already stored in the frame memory 52 in pixels near a part (block) of a processing target in the computing unit 43 and supplies the image to the computing units 43, 51.

Concerning the picture to which intra-coding is performed, when the prediction image is supplied to the computing unit 43 from the intra prediction unit 53 in the manner as described above, the prediction image supplied from the intra prediction unit 53 is subtracted from the picture supplied from the image sorting buffer 42 in the computing unit 43.

In the computing unit 51, the prediction image subtracted in the computing unit 43 is added to data supplied from the inverse orthogonal transformation unit 50.

On the other hand, a non-intra picture to which inter-coding is performed is supplied from the image sorting buffer 42 to the computing unit 43 and the motion prediction/motion compensation unit 54.

The motion prediction/motion compensation unit 54 reads the picture of the decoded image referred to on the motion prediction of the non-intra picture from the image sorting buffer 42 from the frame memory 52 as a reference image. The motion prediction/motion compensation unit 54 further detects motion vectors concerning the non-intra picture from the image sorting buffer 42 by using the reference image from the frame memory 52.

Then, the motion prediction/motion compensation unit 54 generates the prediction image of the non-intra picture by performing motion compensation to the reference image in accordance with the motion vectors, and supplies the image to the computing units 43, 51. The block size in the motion compensation may be fixed or variable.

In the computing unit 43, the prediction image supplied from the intra prediction unit 53 is subtracted from the non-intra picture supplied from the image sorting buffer 42, and after that, coding is performed in the same manner as in the case of the intra picture.

An intra prediction mode which is a mode in which the intra prediction unit 53 generates the prediction image is supplied to the reversible coding unit 46 from the intra prediction unit 53. The motion vectors obtained by the motion prediction/motion compensation unit 54 as well as a motion compensation prediction mode which is a mode in which the motion prediction/motion compensation unit 54 performs motion compensation are supplied to the reversible coding unit 46 from the motion prediction/motion compensation unit 54.

Additionally, DPB output time information generated by a not-shown control unit controlling the entire coding circuit 22 is also supplied to the reversible coding unit 46.

In the reversible coding unit 46, information necessary for decoding such as the intra prediction mode, the motion vectors, the motion compensation prediction mode and a picture type of each picture is reversibly coded, which is included in a header of the coded data. Furthermore, the DPB output time information is added to coded data of L images in the reversible coding unit 46.

### [Explanation of Bit Stream]

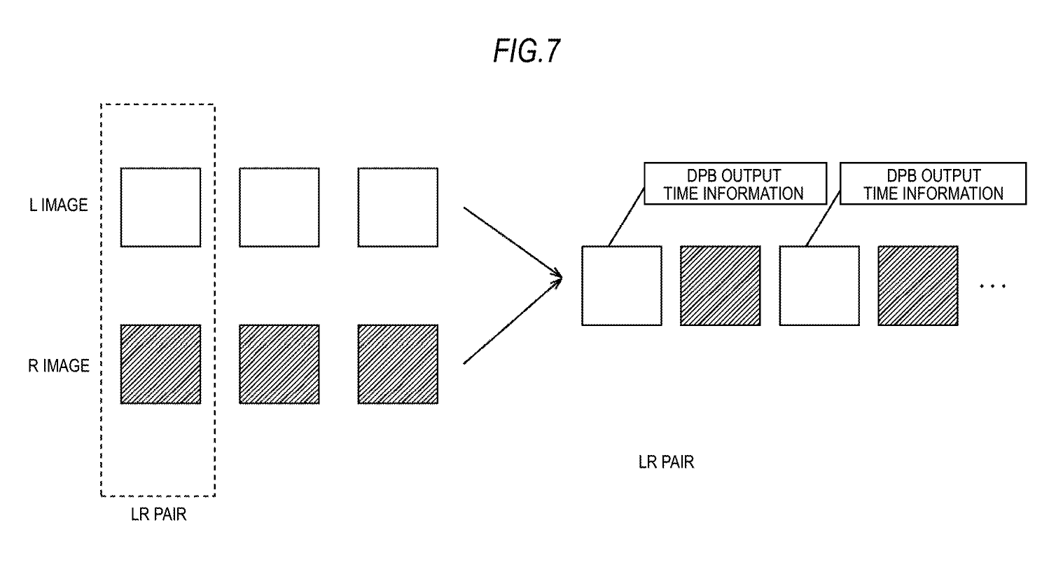

FIG. 7 is a diagram for explaining an example of the bit stream outputted from the coding circuit 22.

As shown in FIG. 7, in the coding circuit 22, image data of L images and image data of R images are multiplexed in the time direction in pairs of LR, and the L images and the R images are coded in this order. Then, the DPB output time information is added only to the coded data of L images obtained as a result of the coding, and the DPB output time information is not added to the coded data of R images.

Accordingly, a video decoding device which decodes the above bit stream can recognize a decoded result of the coded data to which the DPB output time information is added as image data of an L image and can recognize a decoded result of the coded data to which the DPB output time information is not added which has been decoded just after the coded data of the above as image data of an R image which constitutes the same LR pair with the L image. That is, the video decoding device can recognize the LR pair.

For example, when the DPB output time information is added to the coded data of the first image and the DPB output time information is not added to the coded data of the second image as shown in FIG. 7, the video decoding device can recognize the coded data of the first image and the coded data of the second image as the coded data of the LR pair. As a result, a 3D image can be displayed.

### [Example of Syntax of DPB Output Time Information]

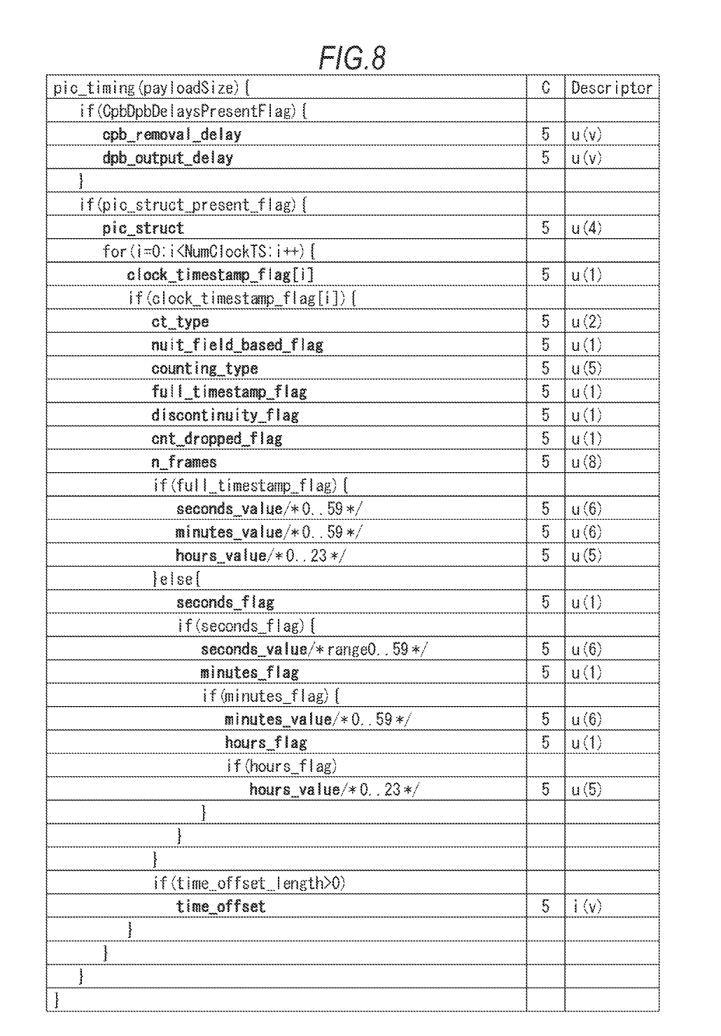

FIG. 8 is a chart showing an example of syntax of the DPB output time information.

The fourth paragraph from the top in FIG. 8 is DPB output time information (dpb_output_delay).

### [Explanation of Processing of Coding System]

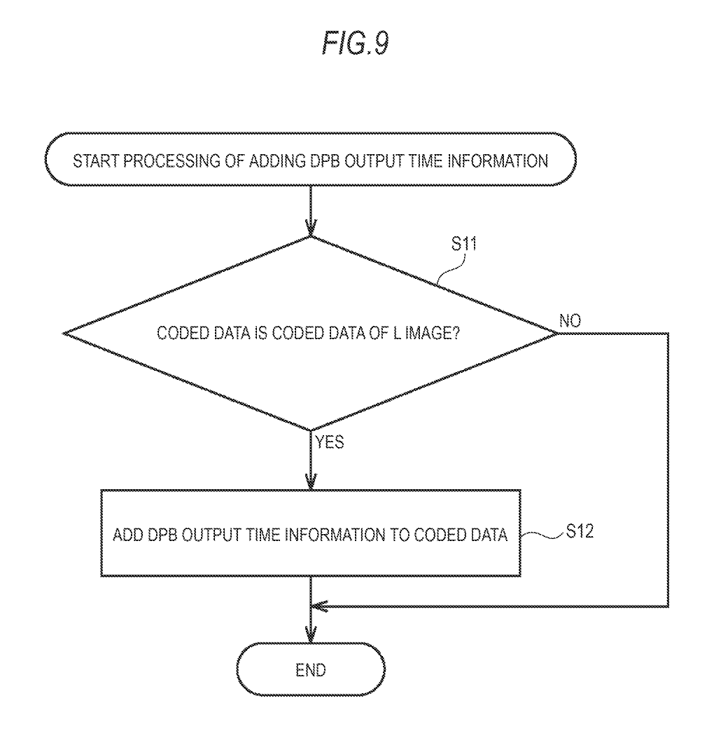

FIG. 9 is a flowchart for explaining processing of adding DPB output time information by the reversible coding unit 46 of the coding system 10 (FIG. 6). The processing of adding DPB output time information is started, for example, when the reversible coding unit 46 generates the coded data of respective pictures.

In Step S11 of FIG. 9, the reversible coding unit 46 determines whether the generated coded data is the coded data of the L image or not. When it is determined that the generated coded data is the coded data of the L image in Step S11, DPB output time information generated by the not-shown control unit is added to the coded data and ends the processing.

On the other hand, when it is determined that the generated coded data is not the coded data of the L image in Step S11, that is, when the generated coded data is coded data of the R image, the processing of Step S12 is not performed and the processing is ended. That is to say, the DPB output time information is not added to the coded data of the R image.

The video synthesis circuit 21 is provided in the video coding device 13 in the coding system 10 of FIG. 1, however, the video synthesis circuit 21 may be provided at the outside of the video coding device 13. In this case, the image signals of the L images imaged by the left-eye imaging device 11 and the image signals of the R images imaged by the right-eye imaging device 12 are multiplexed in the video synthesis circuit 21, and a multiplexed signal is inputted to the video coding device 13.

### [Another Configuration Example of Coding System According to Embodiment]

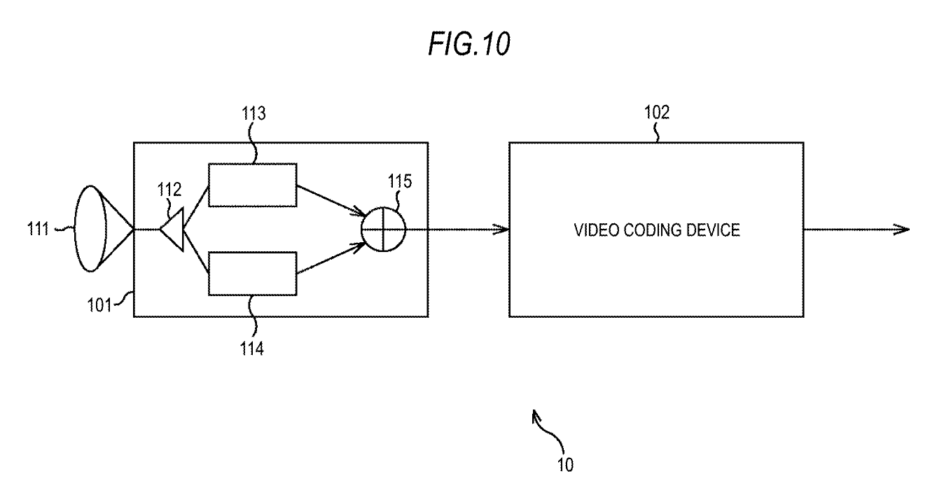

FIG. 10 is a block diagram showing another configuration example of the coding system to which the embodiment of the invention is applied.

The coding system 10 of FIG. 10 includes an imaging device 101 and a video coding device 102. In the coding system 10, L images and R images are imaged by one imaging device 101, and image signals of the L images and image signals of the R images are multiplexed to be inputted to the video coding device 102 in serial order.

Specifically, the imaging device 101 includes an imaging unit 111, a branch unit 112, two imaging processing units 113, 114 and a synthesis unit 115. The imaging unit 111 performs imaging under control of the imaging processing unit 113 and supplies image signals obtained by the imaging to the imaging processing unit 113 through the branch unit 112. The imaging unit 111 also performs imaging under control of the imaging processing unit 114 and supplies image signals obtained by the imaging to the imaging processing unit 114 through the branch unit 112.

The imaging processing unit 113 controls the imaging unit 111 to perform imaging at the same timing as imaging timing of the imaging processing unit 114 or at continuous different timings. The imaging processing unit 113 supplies image signals supplied as a result of the imaging from the branch unit 112 to the synthesis unit 115.

The imaging processing unit 114 controls the imaging unit 111 to perform imaging at the same timing as imaging timing of the imaging processing unit 113 or at continuous different timings. The imaging processing unit 114 supplies image signals supplied as a result of the imaging from the branch unit 112 to the synthesis unit 115 as image signals of R images.

The synthesis unit 115 multiplexes image signals of L images supplied from the imaging processing unit 113 and image signals of R images supplied from the imaging processing unit 114 in pairs of LR in the time direction to output the multiplexed signal to the video coding device 102.

The video coding device 102 is configured by the coding circuit 22 of FIG. 2, performing coding complying with the AVC coding method to the multiplexed signal supplied from the synthesis unit 115.

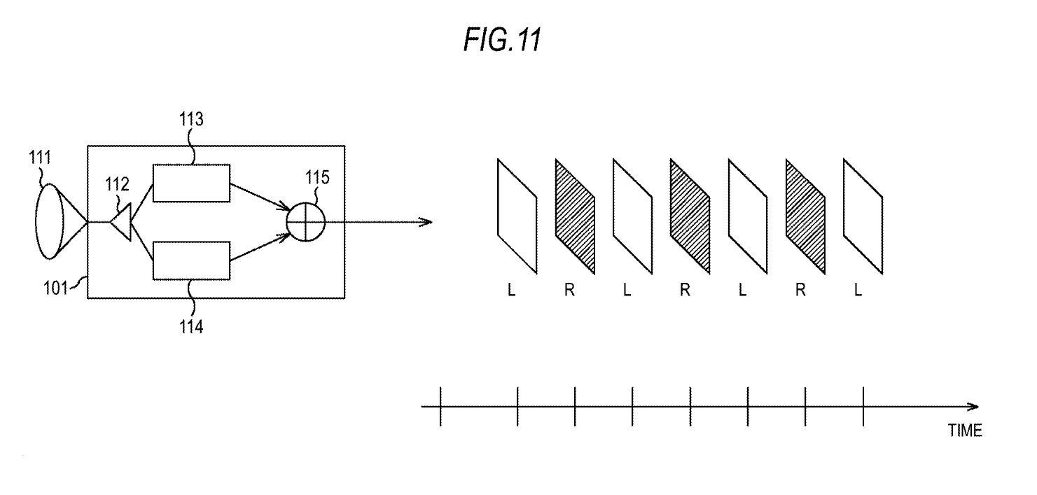

FIG. 11 is a diagram for explaining the multiplexed signal outputted from the synthesis unit 115.

In the synthesis unit 115, image signals of L images imaged under control of the imaging processing unit 113 and image signals of R images imaged under control of the imaging processing unit 114 are multiplexed in pairs of LR in the time direction. As a result, the multiplexed signal outputted from the synthesis unit 115 will be an imaging signal in which image signals of L images and image signals of R images are alternately repeated as shown in FIG. 11.

### [Configuration Example of Decoding System]

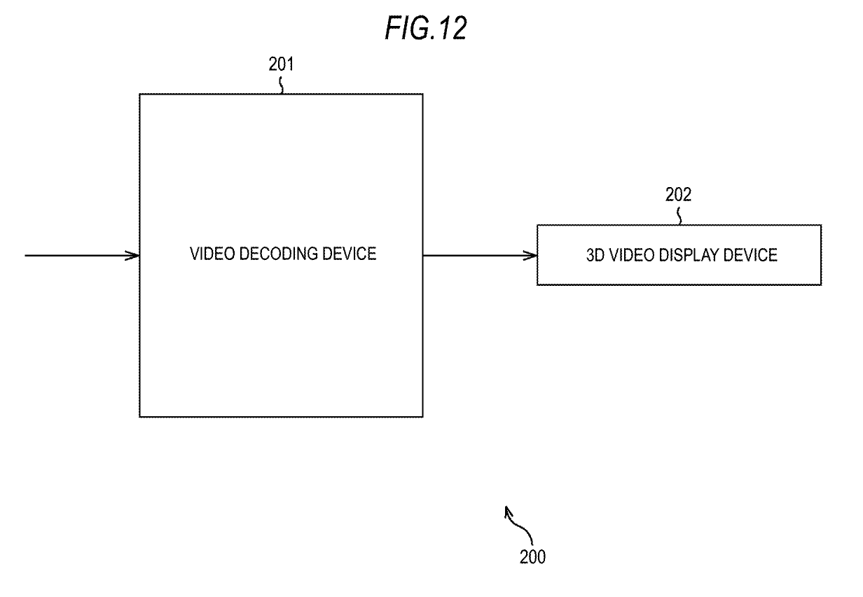

FIG. 12 is a block diagram showing a configuration example of a decoding system which decodes the bit stream outputted from the above coding system 10.

A decoding system 200 of FIG. 12 includes a video decoding device 201 and a 3D video display device 202.

The video decoding device 201 receives the bit stream outputted from the coding system 10 and decodes the bit stream by a method corresponding to the AVC coding method. The video decoding device 201 outputs image signals which are analog signals obtained by the decoding to the 3D video display device 202 in pairs of LR.

The 3D video display device 202 displays 3D images based on image signals of L images and image signals of R images inputted from the video decoding device 201 in pairs of LR. Accordingly, the user can view stereoscopic images.

As the 3D video display device 202, a display device which displays LR pairs at the same timing may be used or a display device which displays LR pairs at continuous different timings may be used. As the display devices which display LR pairs at continuous different timings, there are a display device interleaving L images and R images line by line and alternately displaying images in units of fields, a display device alternately displaying L images and R images in units of frames as images with a high frame rate and the like.

### [Configuration Example of Video Decoding Device]

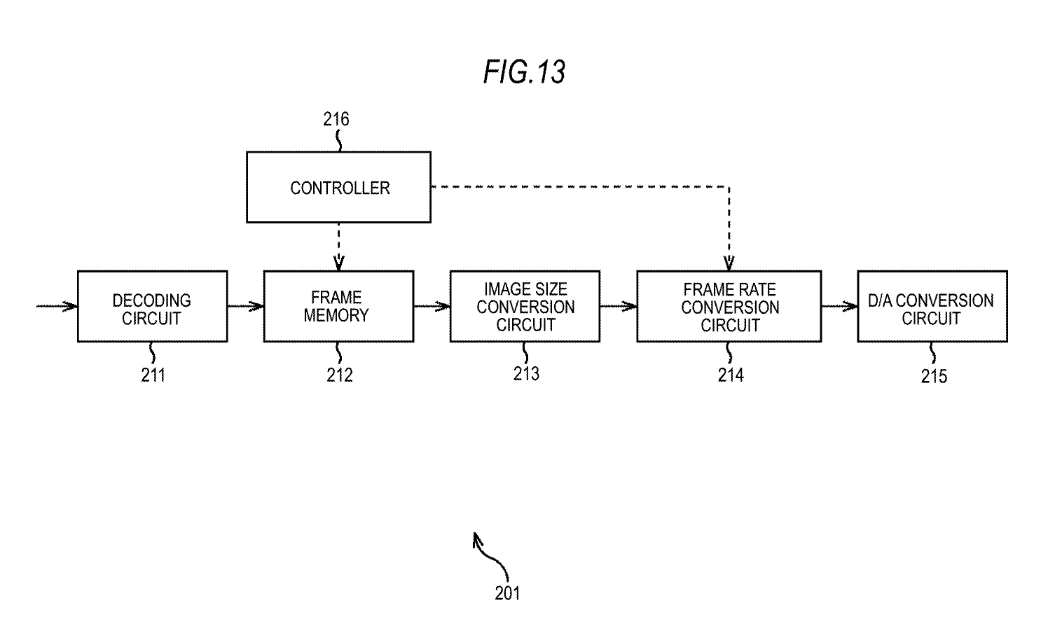

FIG. 13 is a block diagram showing a configuration example of the video decoding device 201 of FIG. 12.

As shown in FIG. 13, the video decoding device 201 includes a decoding circuit 211, a frame memory 212, an image size conversion circuit 213, a frame rate conversion circuit 214, a D/A conversion circuit 215 and a controller 216.

The decoding circuit 211 receives the bit stream outputted from the coding system 10 and decodes the bit stream by the system corresponding to the AVC coding system. The decoding circuit 211 recognizes image data of LR pairs from image data which is a digital signal obtained by the decoding based on the DPB output time information included in the bit stream. The decoding circuit 211 also supplies image data of LR pairs obtained as the result of decoding to the frame memory 212 based on the DPB output time information.

The frame memory 212 stores image data supplied from the decoding circuit 211. The frame memory 212 reads out stored image data of L images and image data of R images in pairs of LR under control of the controller 216 and outputs the data to the image size conversion circuit 213.

The image size conversion circuit 213 expands or contracts the image size of image data of LR pairs supplied from the frame memory 212 to a predetermined size, respectively, and supplies the data to the frame rate conversion circuit 214.

The frame rate conversion circuit 214 outputs image data of LR pairs while controlling output timing of image data of LR pairs supplied from the image size conversion circuit 213 so that the frame rate of L images and R images will be a predetermined rate under control of the controller 216.

The D/A conversion circuit 215 performs D/A conversion to image data of LR pairs outputted from the frame rate conversion circuit 214 and outputs image signals which are analog signals obtained as the result of conversion to the 3D video display device 202.

The controller 216 controls the frame memory 212 to read out image data in pairs of LR. The controller 216 also controls the frame rate conversion circuit 214 to convert the frame rate of image data of L images and R images outputted from the image size conversion circuit 213 into a predetermined frame rate and to output the image data.

### [Configuration Example of Decoding Circuit]

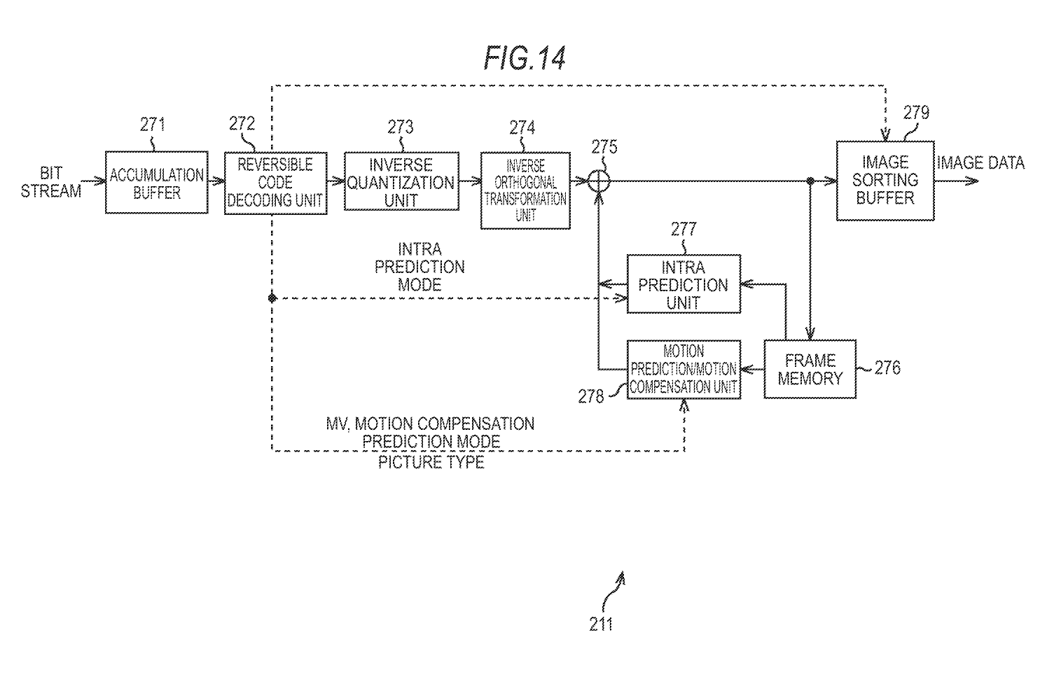

FIG. 14 is a block diagram showing a configuration example of the decoding circuit 211 of FIG. 13.

An accumulation buffer 271 receives the bit stream from the coding system 10 and temporarily stores the bit stream.

A reversible coding/decoding unit 272 decodes the quantized value and information necessary for decoding images such as the intra prediction mode, the motion vectors, the motion compensation prediction mode and the picture type of each picture included in the header of the coded data by performing processing such as variable length decoding and arithmetic decoding to the bit stream from the accumulation buffer 271 based on the format of the bit stream.

The quantized value obtained by the reversible coding/decoding unit 272 is supplied to an inverse quantization unit 273 and the intra prediction mode is supplied to an intra prediction unit 277. The motion vectors (MV), the motion compensation prediction mode and the picture type obtained by the reversible coding/decoding unit 272 are supplied to a motion prediction/motion compensation unit 278.

The reversible coding/decoding unit 272 further extracts the DPB output time information from the bit stream and supplies the information to an image sorting buffer 279.

The inverse quantization unit 273, an inverse orthogonal transformation unit 274, a computing unit 275, a frame memory 276, the intra prediction unit 277 and the motion prediction/motion compensation unit 278 perform the same processing as the inverse quantization unit 49, the inverse orthogonal transformation unit 50, the computing unit 51, the frame memory 52, the intra prediction unit 53 and the motion prediction/motion compensation unit 54 of FIG. 6, thereby decoding images (decoded image can be obtained).

That is, the inverse quantization unit 273 inversely quantizes the quantized value from the reversible coding/decoding unit 272 into a transform coefficient and supplies data to the inverse orthogonal transformation unit 274.

The inverse orthogonal transformation unit 274 performs inverse orthogonal transformation such as inverse discrete cosine transform or inverse Karhunen-Loeve transform to the transform coefficient from the inverse quantization unit 273 based on the format of the bit stream and supplies data to the computing unit 275.

The computing unit 275 adds the pixel value of the prediction image supplied from the intra prediction unit 277 to intra-picture data in data supplied from the inverse orthogonal transformation unit 274 according to need, thereby obtaining the decoded image of the intra picture. The computing unit 275 adds the pixel value of the prediction image supplied from the motion prediction/motion compensation unit 278 to non-intra picture data in data supplied from the inverse orthogonal transformation unit 274, thereby obtaining the decoded image of the non-intra picture.

The decoded images obtained in the computing unit 275 are supplied to the frame memory 276 as well as to the image sorting buffer 279 if necessary.

The frame memory 276 temporarily stores the decoded image supplied from the computing unit 275 and supplies the decoded image to the intra prediction unit 277 and the motion prediction/motion compensation unit 278 as a reference image used for generating the prediction image according to need.

When data to be processed in the computing unit 275 is data of the intra picture, the intra prediction unit 277 generates the prediction image of the intra picture by using the decoded image as the reference image from the frame memory 276 according to need and supplies the image to the computing unit 275.

That is, the intra prediction unit 277 generates the prediction image from pixels already stored in the frame memory 276 in pixels near a part (block) of a processing target in the computing unit 275 in accordance with the intra prediction mode from the reversible coding/decoding unit 272 and supplies the image to the computing unit 275.

On the other hand, when data to be processed in the computing unit 275 is non-intra picture data, the motion prediction/motion compensation unit 278 generates the prediction image of the non-intra picture and supplies the image to the computing unit 275.

That is, the motion prediction/motion compensation unit 278 reads out the picture of decoded image used for generating the prediction image as a reference image from the frame memory 276 in accordance with the picture type and the like from the reversible coding/decoding unit 272. The motion prediction/motion compensation unit 278 further generates the prediction image by performing motion compensation in accordance with the motion vectors and the motion compensation prediction mode from the reversible coding/decoding unit 272 to the reference image from the frame memory 276 and supplies the image to the computing unit 275.

In the computing unit 275, the prediction image supplied from the intra prediction unit 277 or the motion prediction/motion compensation unit 278 is added to data supplied from the inverse orthogonal transformation unit 274 as described above, thereby decoding (pixel value of) the picture.

The image sorting buffer 279 recognizes whether image data of the picture (decoded image) from the computing unit 275 is image data of the L image or image data of the R image according to whether the DPB output time information is supplied from the reversible coding/decoding unit 272. The image sorting buffer 279 temporarily stores image data of the picture from the computing unit 275.

The image sorting buffer 279 reads out image data of the picture of the L image to which the DPB output time information is added in image data of stored pictures and image data of the picture of the R image to which the DPB output time information is not added which is immediately subsequent to the picture in the coding order in sequence based on the DPB output image information supplied from the reversible coding/decoding unit 272, thereby sorts arrangement of pictures into original arrangement (display order) and outputs the pictures to the frame memory 212 (FIG. 13) in pairs of LR.

Here, the image sorting buffer 279 and the frame memory 276 correspond to the DPB in the decoding device of FIG. 14.

### [Explanation of Processing of Decoding Circuit]

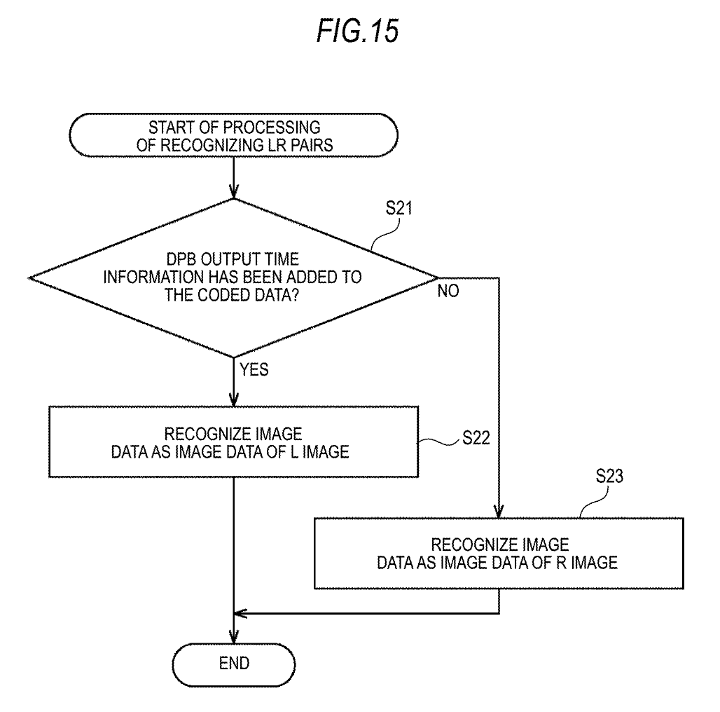

FIG. 15 is a flowchart for explaining processing of recognizing LR pairs by the image sorting buffer 279 of the decoding circuit 211 (FIG. 14). The processing of recognizing LR pairs is started, for example, when image data of respective pictures obtained by the decoding from the computing unit 275 is inputted.

In Step S21 of FIG. 15, the image sorting buffer 279 determines whether DPB output time information has been added to the coded data of image data of the picture before decoding supplied from the computing unit 275. Specifically, the image sorting buffer 279 determines whether DPB output time information has been supplied from the reversible coding/decoding unit 272 or not.

When it is determined that DPB output time information has been added to the coded data in Step S21, the image sorting buffer 279 recognizes image data supplied from the computing unit 275 as image data of the L image in Step S22 and the processing is ended.

When it is determined that DPB output time information has not been added to coded data in Step S21, the image sorting buffer 279 recognizes image data supplied from the computing unit 275 as image data of the R image in Step S23 and the processing is ended.

The image data of the L image recognized as described above and image data of the R image which is immediately subsequent to the image data in the coding order are outputted to the frame memory 212 as image data of the LR pair.

As described above, the coding system 10 adds DPB output time information only to the coded data of the L image in the LR pair which is previous in the coding order. Accordingly, the decoding system 200 can recognize that a decoded result of the coded data to which DPB output time information is added and a decoded result of the coded data to which DPB output time information is not added which has been decoded subsequently to the coded data are the decoded results of the LR pair. As a result, the decoding system 200 can display 3D images.

In the above explanation, the coding order of the LR pair is previously determined, however, the coding order of the LR pair can be changed. In this case, for example, coding order information indicating the coding order of the LR pair is added to the coded data, and the image sorting buffer 279 recognizes which of the picture of the L image and the picture of the R image is the picture supplied from the computing unit 275 based on with or without acquisition of DPB output time information and the coding order information.

The image to which DPB output time information is added may be the image in a predetermined order in the coding order of the LR pair. That is, the DPB output time information may be added to the image which is previous in the coding order as in the above explanation as well as the image which is in the subsequent order. When the DPB output time information is added to the image which is subsequent in the coding order, the decoding system 200 recognizes that a decoded result of the coded data to which DPB output time information is added and a decoded result of the coded data to which DPB output time information is not added which has been decoded previously to the coded data are the decoded results of the LR pair.

### [Another Method of Adding DPB Output Time Information]

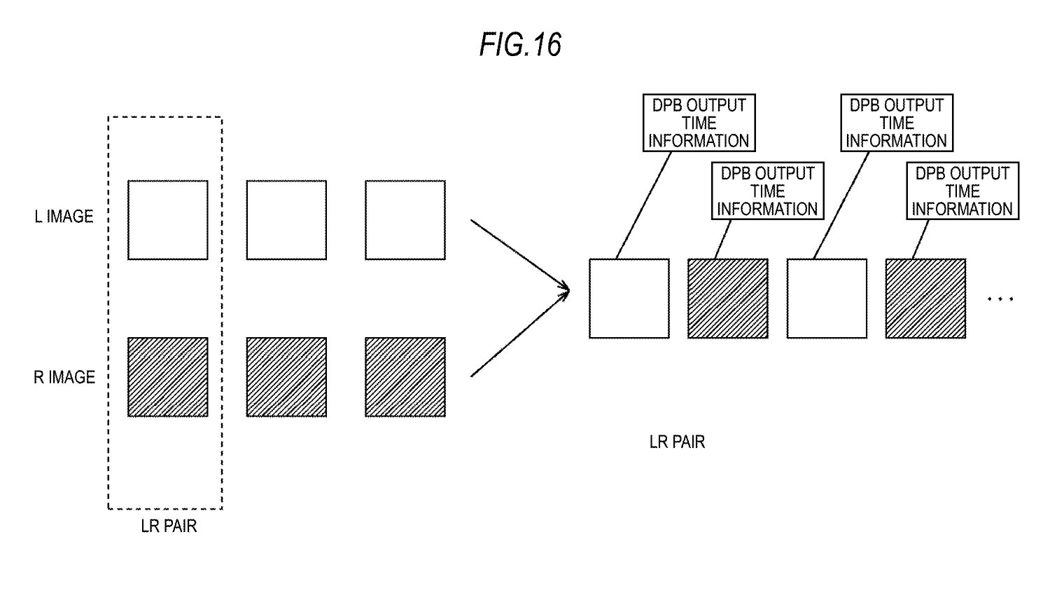

In the above explanation, the DPB output time information is added only to the coded data of the L image, however, it is also preferable that the DPB output time information is added both to coded data of the L image and coded data of the R image as shown in FIG. 16. In this case, the video coding device can allow the video decoding device to recognize the LR pair by adding a flag indicating the L image to coded data of the L image or adding information indicating the LR pair to coded data of the LR pair.

In the embodiment, the DPB output time information and the coding order information are added to (written in) the coded data, however, the DPB output time information and the coding order information may be connected to image data (or the bit stream).

Here, the “connection” indicates a state in which image data (or the bit stream) and DPB output time information are linked to each other. Therefore, image data and DPB output time information to be connected to each other may be transmitted in different transmission lines. Additionally, image data (or the bit stream) and DPB output time information to be connected to each other may be recorded in different recoding media (or different recording areas in the same recording medium). A unit in which image data (or the bit stream) and DPB output time information are linked to each other may be a unit of coding processing (1 frame, plural frames etc.).

[Explanation of Computer to which Embodiment of the Invention is Applied]

Next, the above series of processing can be performed by hardware as well as software. When the series of processing is performed by software, programs included in the software are installed to a general-purpose computer and the like.

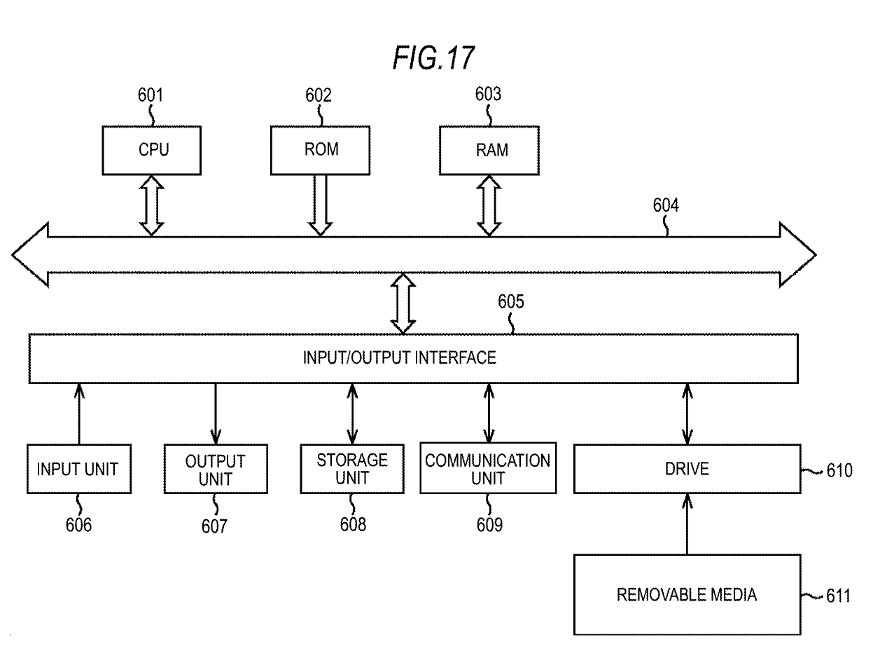

FIG. 17 shows a configuration example of a computer to which programs executing the above series of processing are installed according to an embodiment.

Programs can be previously recorded in a storage unit 608 and a ROM 602 as storage media built in the computer.

Alternatively, programs can be stored (recorded) in a removable media 611. The removable media 611 can be provided as so-called packaged software. Here, there are, for example, a flexible disc, a CD-ROM (Compact Disc Read Only Memory), an MO (Magneto Optical) disc, a DVD (Digital Versatile Disc), a magnetic disc, a semiconductor memory as the removable media 611.

Programs can be not only installed to the computer from the above-described removable media 611 through a drive 610 but also downloaded to the computer through communication networks or broadcasting networks and installed in the built-in storage unit 608. That is, programs are transferred to the computer by wireless, for example, from a download site through a satellite for digital satellite broadcasting, or transferred to the computer by wire through networks such as LAN (Local Area Network) and Internet.

The computer houses a CPU (Central Processing Unit) 601 and an input/output interface 605 is connected to the CPU 601 through a bus 604.

When an instruction is inputted through, for example, an input unit 606 operated by the user through the input/output interface 605, the CPU 601 executes programs stored in the ROM (Read Only Memory) 602 in accordance with the instruction. The CPU 601 also executes programs stored in the storage unit 608 by loading them to a RAM (Random Access Memory) 603.

The CPU 601 performs processing corresponding to the above flowchart or processing performed by the configuration of the block diagram explained as the above. Then, the CPU 601 allows an output unit 607 to output the processing result through, for example, the input/output interface 605 or allows a communication unit 609 to transmit the processing result, and further allows the storage unit 608 to record the processing result therein according to need.

The input unit 606 includes a keyboard, a mouse, a microphone and the like. The output unit 607 includes an LCD (Liquid Crystal Display), a speaker and the like.

In the specification, it is not always necessary that processing performed by the computer in accordance with programs is performed in time series along the order described as the flowchart. That is, processing performed by the computer in accordance with programs includes processing performed in parallel or individually (for example, parallel processing and processing by objects).

Programs may be processed by one computer (processor) or distributed processing may be performed by plural computers. Furthermore, programs may be executed by being transferred to a distant computer.

In the specification, the system indicates the entire apparatus including plural devices.

The embodiment of the invention is not limited to the above embodiment and can be modified variously within a scope not departing from the gist of the invention.

For example, the above coding system 10 and the decoding system 200 can be applied to arbitrary electronic apparatuses. Examples thereof will be explained below.

### [Configuration Example of Television Receiver]

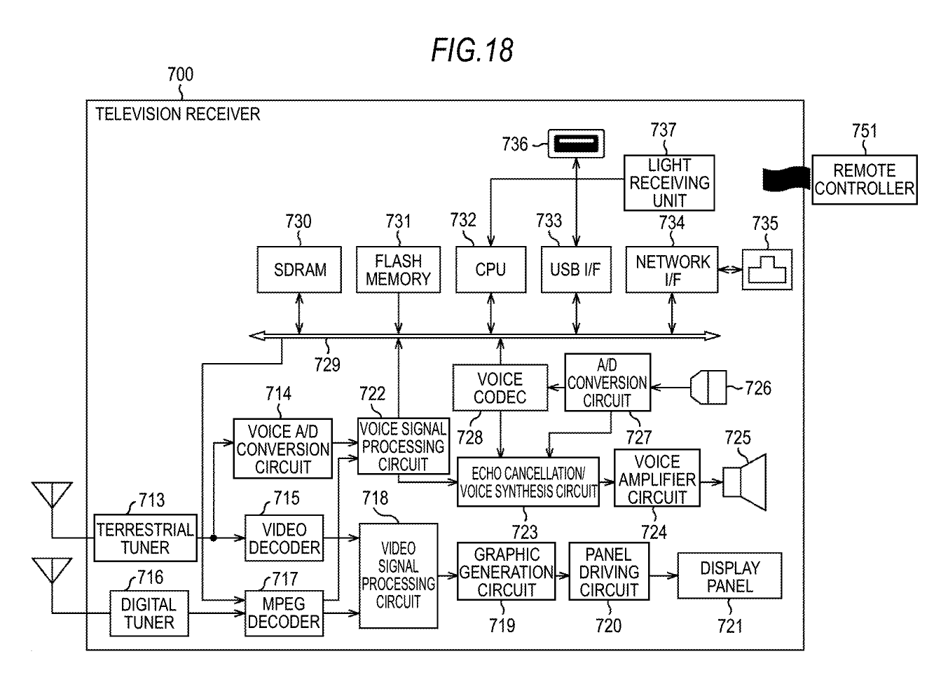

FIG. 18 is a block diagram showing a fundamental configuration example of a television receiver using the decoding system to which the embodiment of the invention is applied.

A television receiver 700 of FIG. 18 acquires a bit stream obtained by the above coding system 10 as a broadcasting signal or content data of digital broadcasting, and displays stereoscopic images by performing processing which is the same as the decoding system 200.

A terrestrial tuner 713 of the television receiver 700 receives a broadcast wave signal of terrestrial analog broadcasting through an antenna, demodulates the signal and acquires an image signal to be supplied to a video decoder 715. The video decoder 715 performs decoding processing to a video signal supplied from the terrestrial tuner 713, and supplies an obtained digital component signal to a video signal processing circuit 718.

The video signal processing circuit 718 performs given processing such as noise filtering to video data supplied from the video decoder 715 and supplies obtained video data to a graphic generation circuit 719.

The graphic generation circuit 719 generates video data of a program to be displayed on a display panel 721 and image data by processing based on applications supplied through networks, supplies the generated video data or image data to a panel driving circuit 720. The graphic generation circuit 719 appropriately performs processing of supplying video data to the panel driving circuit 720, which is obtained by generating video data (graphics) for displaying a screen used for selecting items by the user and superimposing the data on video data of a program.

The panel driving circuit 720 drives the display panel 721 based on data supplied from the graphic generation circuit 719 and displays program video and various screens described above on the display panel 721.

The display panel 721 displays program video and the like under control of the panel driving circuit 720.

The television receiver 700 also includes a voice A/D (Analog/Digital) conversion circuit 714, a voice signal processing circuit 722, an echo cancellation/voice synthesis circuit 723, a voice amplifier circuit 724 and a speaker 725.

The terrestrial tuner 713 acquires not only the video signal but also a voice signal by demodulating the received broadcast wave signal. The terrestrial tuner 713 supplies the acquired voice signal to the voice A/D conversion circuit 714.

The voice A/D conversion circuit 714 performs A/D conversion processing to the voice signal supplied from the terrestrial tuner 713, and supplies the obtained digital voice signal to the voice signal processing circuit 722.

The voice signal processing circuit 722 performs given processing such as noise filtering to the voice data supplied from the voice A/D conversion circuit 714 and supplies the obtained voice data to the echo cancellation/voice synthesis circuit 723.

The echo cancellation/voice synthesis circuit 723 supplies the voice data supplied from the voice signal processing circuit 722 to the voice amplifier circuit 724.

The voice amplifier circuit 724 performs D/A conversion processing and amplification processing to the voice data supplied from the echo cancellation/voice synthesis circuit 723 and adjusts voice to given volume to be outputted from the speaker 725.

The television receiver 700 also includes a digital tuner 716 and an MPEG decoder 717.

The digital tuner 716 receives a broadcast wave signal of digital broadcasting (terrestrial digital broadcast, BS (Broadcasting Satellite)/CS (Communications Satellite) digital broadcasting) through an antenna, demodulates the signal and acquires MPEG-TS (Moving Picture Experts Group-Transport Stream) to be supplied to the MPEG decoder 717.

The MPEG decoder 717 releases scramble given to the MPEG-TS supplied from the digital tuner 716 and extracts a stream including program data as a playback target (viewing target). The MPEG decoder 717 decodes voice packets included in the extracted stream and supplies the obtained voice data to the voice signal processing circuit 722 as well as decodes video packets included in the stream, then, supplies the obtained video data to the video signal processing circuit 718. The MPEG decoder 717 supplies EPG (Electronic Program Guide) data extracted from MPEG-TS to a CPU 732 through a not-shown path.

The video data supplied from the MPEG decoder 717 receives given processing in the video signal processing circuit 718 in the same manner as video data supplied from the video decoder 715. The video data to which given processing has been performed is supplied to the display panel 721 through the panel driving circuit 720 with video data generated by the graphic generation circuit 719 being superimposed appropriately, and the image is displayed.

The television receiver 700 performs processing similar to the above video decoding device 201 as processing of decoding video packets and displaying image on the display panel 721. As a result, it is possible to recognize, for example, LR pairs of the program and to display stereoscopic images of the program.

The voice data supplied from the MPEG decoder 717 receives given processing in the voice signal processing circuit 722 as in the same manner as voice data supplied from the voice A/D conversion circuit 714. Then, the voice data to which given processing has been performed is supplied to the voice amplifier circuit 724 through the echo cancellation/voice synthesis circuit 723 and D/A conversion processing and amplification processing are performed. As a result, the voice adjusted to given volume is outputted from the speaker 725.

The television receiver 700 also has a microphone 726 and an A/D conversion circuit 727.

The A/D conversion circuit 727 receives a voice signal of the user taken by the microphone 726 provided at the television receiver 700 for voice conversation. The A/D conversion circuit 727 performs A/D conversion processing to the received voice signal and supplies the obtained digital voice data to the echo cancellation/voice synthesis circuit 723.

When voice data of a user (user A) of the television receiver 700 is supplied from the A/D conversion circuit 727, the echo cancellation/voice synthesis circuit 723 performs echo cancellation with respect to the voice data of the user A. Then, the echo cancellation/voice synthesis circuit 723 outputs voice data obtained by synthesizing the voice data with another voice data after the echo cancellation from the speaker 725 through the voice amplifier circuit 724.

The television receiver 700 further includes a voice codec 728, an internal bus 729, an SDRAM (Synchronous Dynamic Random Access Memory) 730, a flash memory 731, the CPU 732, a USB (Universal Serial Bus) I/F 733 and a network I/F 734.

The A/D conversion circuit 727 receives a voice signal of the user taken by the microphone 726 provided at the television receiver 700 for voice conversation. The A/D conversion circuit 727 performs A/D conversion processing to the received voice signal and supplies the obtained digital voice data to the voice codec 728.

The voice codec 728 converts voice data supplied from the A/D conversion circuit 727 into data of a given format for transmitting data through a network, and supplies the data to the network I/F 734 through the internal bus 729.

The network I/F 734 is connected to a network through a cable attached to a network terminal 735. The network I/F 734 transmits, for example, voice data supplied from the voice codec 728 to another device connected to the network. The network I/F 734 also receives voice data transmitted from another device connected through the network through the network terminal 735 and supplies the voice data to the voice codec 728 through the internal bus 729.

The voice codec 728 converts the voice data supplied from the network I/F 734 into data of a given format and supplies the voice data to the echo cancellation/voice synthesis circuit 723.

The echo cancellation/voice synthesis circuit 723 performs echo cancellation with respect to voice data supplied from the voice codec 728 and outputs voice data obtained by synthesizing the data with another voice data from the speaker 725 through the voice amplifier circuit 724.

The SDRAM 730 stores various data necessary when the CPU 732 performs processing.

The flash memory 731 stores programs executed by the CPU 732. The programs stored in the flash memory 731 are read out from the CPU 732 at predetermined timing such as when activating the television receiver 700. The flash memory 731 also stores EPG data acquired through digital broadcasting, data acquired from a given server through the network and so on.

For example, the flash memory 731 stores MPEG-TS including content data acquired from the given server through the network under control of the CPU 732. The flash memory 731 supplies the MPEG-TG to the MPEG decoder 717 through the internal bus 729 under control of, for example, the CPU 732.

The MPEG decoder 717 processes the MPEG-TS in the same manner as the case of the MPEG-TS supplied from the digital tuner 716. As a result, for example, it is possible to recognize LR pairs of content data and display stereoscopic images corresponding to content data.

As described above, the television receiver 700 receives content data including stereoscopic images, voice and the like through the network, decodes the data by using the MPEG decoder 717 and displays the stereoscopic images or outputs voice.

The television receiver 700 includes a light receiving unit 737 receiving an infrared signal transmitted from a remote controller 751.

The light receiving unit 737 receives infrared rays from the remote controller 751 and outputs a control code indicating contents of user operation obtained by the demodulation to the CPU 732.

The CPU 732 executes programs stored in the flash memory 731 and controls the entire operation of the television receiver 700 in accordance with the control code supplied from the light receiving unit 737. The CPU 732 and respective units of the television receiver 700 are connected through a not-shown path.

The USB I/F 733 performs transmission/reception of data between the television receiver 700 and an external device which is connected through a USB cable attached to a USB terminal 736. The network I/F 734 is connected to a network through a cable attached to the network terminal 735, performing transmission/reception of data other than voice data with respect to respective devices connected to the network.

### [Configuration Example of Cellular Phone]

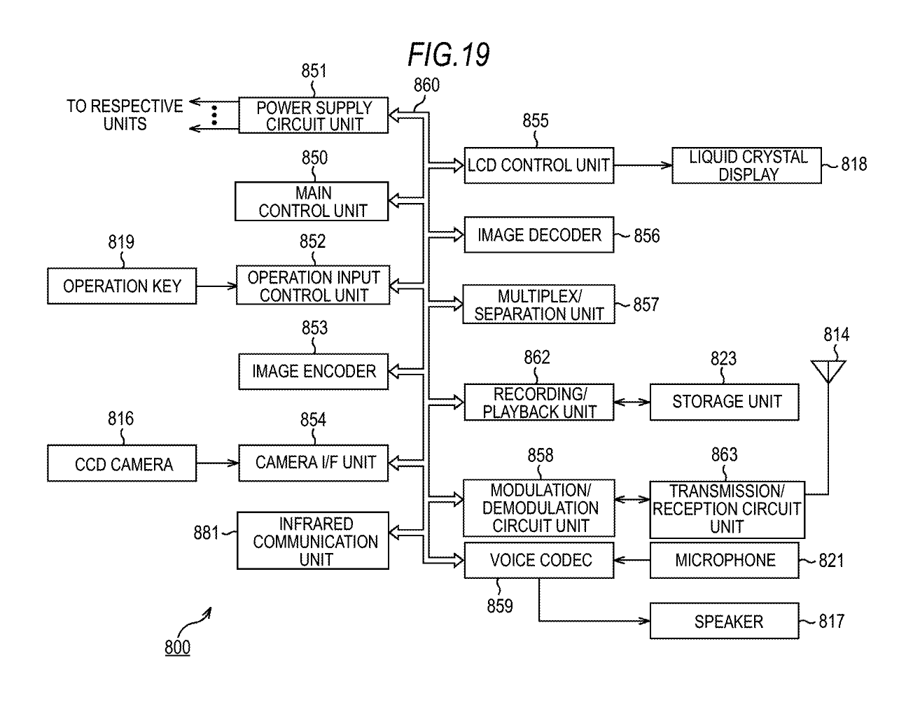

FIG. 19 is a block diagram showing a fundamental configuration example of a cellular phone device using the coding system and the decoding system to which the embodiment of the invention is applied.

A cellular phone device 800 of FIG. 19 performs processing similar to the above coding system 10 and obtains a bit stream for displaying stereoscopic images. The cellular phone device 800 also receives the bit stream obtained by the above coding system 10 and performs the same processing as the decoding system 200 to display stereoscopic images.

The cellular phone device 800 of FIG. 19 includes a main control unit 850 configured to control respective units totally, a power supply circuit unit 851, an operation input control unit 852, an image encoder 853, a camera I/F unit 854, an LCD control unit 855, an image decoder 856, a multiplex/separation unit 857, a recording/playback unit 862, a modulation/demodulation circuit unit 858 and a voice codec 859. These units are connected to one another through a bus 860.

The cellular phone device 800 includes an operation key 819, a CCD (Charge Coupled Devices) camera 816, a liquid crystal display 818, a storage unit 823, a transmission/reception circuit unit 863, an antenna 814, a microphone 821 and a speaker 817.

The power supply circuit unit 851 supplies power from a battery pack to respective units to thereby activate the cellular phone device 800 when a call-end and power key is turned on by user operation.

The cellular phone device 800 performs various operations such as transmission/reception of voice signals, transmission/reception of e-mail and image data, image taking or data recording in various modes such as a voice call mode and a data communication mode based on control of the main control unit 850 including a CPU, a ROM, a RAM and the like.

For example, in the voice call mode, the cellular phone device 800 converts a voice signal collected by the microphone 821 into digital voice data by the voice codec 859, performs spread spectrum processing to the data at the modulation/demodulation circuit unit 858 and performs digital/analog conversion processing as well as frequency conversion processing to the data at the transmission/reception circuit unit 863. The cellular phone device 800 transmits a signal for transmission obtained by the conversion processing to a not-shown base station through the antenna 814. The signal for transmission (voice signal) transmitted to the base station is supplied to a cellular phone device of the other party through a public telephone line network.

Additionally, for example, in the voice call mode, the cellular phone device 800 amplifies the received signal received through the antenna 814 at the transmission/reception circuit unit 863, performs frequency conversion processing as well as analog/digital conversion processing to the signal, performs inverse spread spectrum processing to the signal at the modulation/demodulation circuit unit 858 and converts the signal into an analog voice signal at the voice codec 859. The cellular phone device 800 outputs the analog voice signal obtained by the conversion from the speaker 817.

Furthermore, for example, in the case that e-mail is transmitted in the data communication mode, the cellular phone device 800 receives text data of e-mail inputted by operation of the operation key 819 at the operation input control unit 852. The cellular phone device 800 processes the text data at the main control unit 850 and displays the data on the liquid crystal display 818 as an image through the LCD control unit 855.

The cellular phone device 800 also generates e-mail data in the main control unit 850 based on text data, user instruction and the like received by the operation input control unit 852. The cellular phone device 800 performs spread spectrum processing to the e-mail data at the modulation/demodulation circuit unit 858 and performs digital/analog conversion processing as well as frequency conversion processing to the data at the transmission/reception circuit unit 863. The cellular phone device 800 transmits a signal for transmission obtained by the conversion processing to a not-shown base station through the antenna 814. The signal for transmission (e-mail) transmitted to the base station is supplied to a given address through a network, a mail server and so on.

For example, when receiving e-mail in the data communication mode, the cellular phone device 800 receives a signal transmitted from the base station by the transmission/reception circuit unit 863 through the antenna 814, amplifies the signal and further performs frequency conversion processing as well as analog/digital conversion processing to the signal. The cellular phone device 800 performs inverse spread spectrum processing to the received signal at the modulation/demodulation circuit unit 858 to restore the original e-mail data. The cellular phone device 800 displays the restored e-mail data on the liquid crystal display 818 through the LCD control unit 855.

It is also possible to store the received e-mail data in the storage unit 823 through the recording/playback unit 862 in the cellular phone device 800.

The storage unit 823 is an arbitrary storage medium which is rewritable. The storage unit 823 may be, for example, a semiconductor memory such as a RAM or an internal flash memory, a hard disk, or removable media such as a magnetic disc, a magneto-optic disc, an optical disc, a USB memory and a memory card. Other storage media can be used as a matter of course.

Furthermore, for example, when transmitting image data in the data communication mode, the cellular phone device 800 generates image data by performing imaging by the CCD camera 816. The CCD camera 816 includes optical devices such as a lens and diaphragm, and CCDs as photoelectric conversion elements, which images a subject, converts the intensity of received light into electrical signals to generate image data of the subject image. The image data is compressed and coded by the image encoder 853 through the camera I/F unit 854 by the AVC coding method to be converted into coded image data.

The cellular phone device 800 performs the same processing as the above video coding device 13 as processing of compressing and coding image data generated by imaging. As a result, it is possible to recognize LR pairs of taken images and display stereoscopic images of taken images at the time of decoding.

The cellular phone device 800 multiplexes coded image data supplied from the image encoder 853 with digital voice data supplied from the voice codec 859 at the multiplex/separation unit 857 by a given method. The cellular phone device 800 performs spread spectrum processing to the multiplexed data obtained as a result of multiplexing at the modulation/demodulation circuit unit 858 and performs digital/analog conversion processing as well as frequency conversion processing at the transmission/reception circuit unit 863. The cellular phone device 800 transmits a signal for transmission obtained as the result of the conversion processing to a not-shown base station through the antenna 814. The signal for transmission (image data) transmitted to the base station is supplied to the other party of communication through the network and the like.

When image data is not transmitted, the cellular phone device 800 may display image data and the like generated by the CCD camera 816 on the liquid crystal display 818 through the LCD control unit 855 not through the image encoder 853.

For example, when receiving data of a moving image file linked to an easy web site and so on in the data communication mode, the cellular phone device 800 receives the signal transmitted from the base station at the transmission/reception circuit unit 863 through the antenna 814, amplifies the signal and further performs frequency conversion processing as well as analog/digital conversion processing to the signal. The cellular phone device 800 performs inverse spread spectrum processing to the received signal at the modulation/demodulation circuit unit 858 to restore the original multiplexed data. The cellular phone device 800 separates the multiplexed data at the multiplex/separation unit 857 into coded image data and voice data.

The cellular phone device 800 generates playback moving image data by decoding the coded image data by the decoding method corresponding to the AVC coding method at the image decoder 856, and displays the data on the liquid crystal display 818 through the LCD control unit 855. Accordingly, for example, stereoscopic images of moving image data included in the moving image file linked to the easy web site are displayed on the liquid crystal display 818.

The cellular phone device 800 performs the same processing as the above video decoding device 201 as processing of decoding the coded image data and displaying the data on the liquid crystal display 818. As a result, for example, LR pairs of moving images corresponding to the moving image file linked to the easy web site can be recognized and stereoscopic images of the moving images can be displayed.

In the cellular phone device 800, it is possible to store data linked to the received easy web site and the like in the storage unit 823 through the recording/playback unit 862 as in the case of e-mail.

The cellular phone device 800 can also analyze a two-dimensional code imaged and obtained by the CCD camera 816 at the main control unit 850 to acquire information recorded in the two-dimensional code.

Furthermore, the cellular phone device 800 can perform communication with an external device by infrared rays at an infrared communication unit 881.

In the above description, the CCD camera 816 is used in the cellular phone device 800, however, it is also preferable that an image sensor (CMOS image sensor) using a CMOS (Complementary Metal Oxide Semiconductor) is used instead of the CCD camera 816. Also in this case, the cellular phone device 800 can image subjects and generate image data of subject images as in the case of using the CCD camera 816.

In the above description, the cellular phone device 800 has been explained, and it is possible to apply the above-described coding system and the decoding system in the same manner as in the case of the cellular phone device 800 to any type of apparatus as long as it is an apparatus having the same imaging function and communication function as the cellular phone device 800 such as a PDA (Personal Digital Assistants), a smart phone, a UMPC (Ultra Mobile Personal Computer), a net book and a notebook personal computer.

### [Configuration Example of Hard Disk Recorder]

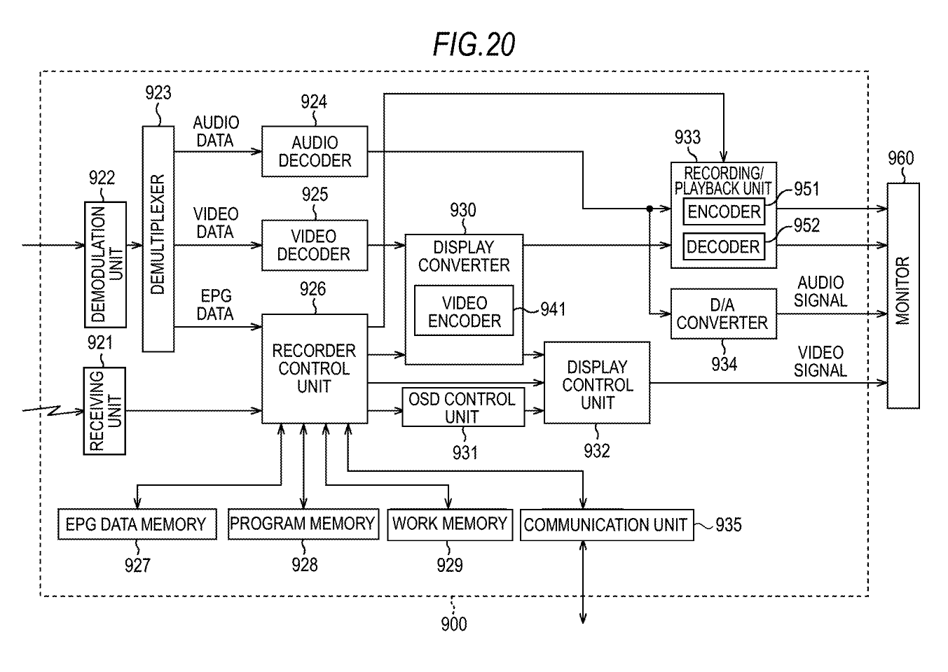

FIG. 20 is a block diagram showing a fundamental configuration example of a hard disk recorder and a monitor using the decoding system to which the embodiment of the invention is applied.

A hard disk recorder (HDD recorder) 900 of FIG. 20 acquires a bit stream obtained by the above coding system 10 as a broadcast wave signal (television signal) and so on transmitted from a satellite or a terrestrial antenna and the like which has been received by a tuner, and stores the signal in the internal hard disk. The hard disk recorder 900 performs the same processing as the decoding system 200 by using the stored bit stream with timing corresponding to an instruction by the user, and displays stereoscopic images of the broadcast wave signal on a monitor 960.

The hard disk recorder 900 includes a receiving unit 921, a demodulation unit 922, a demultiplexer 923, an audio decoder 924, a video decoder 925 and a recorder control unit 926. The hard disk recorder 900 further includes an EPG data memory 927, a program memory 928, a work memory 929, a display converter 930, an OSD (On Screen Display) control unit 931, a display control unit 932, a recording/playback unit 933, a D/A converter 934 and a communication unit 935.

The display converter 930 includes a video encoder 941. The recording/playback unit 933 includes an encoder 951 and a decoder 952.

The receiving unit 921 receives an infrared signal from a remote controller (not shown), converts the signal into an electrical signal and outputs the signal to the recorder control unit 926. The recorder control unit 926 includes, for example, a microprocessor and the like, and performs various processing in accordance with programs stored in the program memory 928. The recorder control unit 926 uses the work memory 929 at this time according to need.

The communication unit 935 is connected to a network and performs communication processing with other devices through the network. For example, the communication unit 935 is controlled by the recorder control unit 926 so as to communicate with a tuner (not shown), and outputs a channel-selection control signal to the tuner in the main.

The demodulation unit 922 demodulates the signal supplied from the tuner and outputs the signal to the demultiplexer 923. The demultiplexer 923 separates the data supplied from the demodulation unit 922 into audio data, the video data and EPG data, and outputs separated data to the audio decoder 924, the video decoder 925 and the recorder control unit 926, respectively.

The audio decoder 924 decodes the inputted audio data by, for example, the MPEG method and outputs the data to the recording/playback unit 933. The video decoder 925 decodes the inputted video data by the method corresponding to the AVC coding method and outputs the data to the display converter 930. The recorder control unit 926 supplies the inputted EPG data to the EPG data memory 927 to be stored therein.

The display converter 930 encodes the video data supplied from the video decoder 925 or the recorder control unit 926 into video data in, for example, an NTSC (National Television Standards Committee) method by the video encoder 941, and outputs the data to the recording/playback unit 933.

The display converter 930 converts the screen size of video data supplied from the video decoder 925 or the recorder control unit 926 into the size corresponding to the size of the monitor 960. The display converter 930 further converts the video data the screen size of which has been converted into video data in the NTSC method by the video encoder 941, converts the data into an analog signal and outputs the signal to the display control unit 932.

The display control unit 932 superimposes an OSD signal outputted by the OSD (On Screen Display) control unit 931 on the video signal inputted by the display converter 930 under control of the recorder control unit 926, outputs the signal on a display of the monitor 960 to be displayed thereon.

The hard disk recorder 900 performs the same processing as the above video decoding device 201 as processing of decoding the video data and displaying images on the monitor 960 in the above manner. As a result, for example, LR pairs of a program can be recognized and stereoscopic images of the program can be displayed.

Audio data outputted by the audio decoder 924 is converted into an analog signal by the D/A converter 934 and supplied to the monitor 960. The monitor 960 outputs the audio signal from an internal speaker.

The recording/playback unit 933 includes a hard disk as a recording medium which records video data and audio data.

The recording/playback unit 933 encodes, for example, audio data supplied from the audio decoder 924 by the encoder 951 in the MPEG method. The recording/playback unit 933 also encodes video data supplied from the video encoder 941 of the display converter 930 by the encoder 951 in the AVC coding method.

The hard disk recorder 900 performs the same processing as the above video coding device 13 as processing of encoding video data in this manner. As a result, it is possible to recognize LR pairs of a program and display stereoscopic images of the program at the time of decoding/playback.

The recording/playback unit 933 also synthesizes coded data of the audio data with coded data of the video data by a multiplexer. The recording/playback unit 933 amplifies the synthesis data by channel-coding the data and writes the data in the hard disk through a recording head.

The recording/playback unit 933 plays back and amplifies data recorded in the hard disk through a playback head, then, separates the data into audio data and video data by the demultiplexer. The recording/playback unit 933 decodes the audio data by the decoder 952 in the method corresponding to the MPEG coding system and decodes the video data by the method corresponding to the AVC coding method. The recording/playback unit 933 performs D/A conversion to the decoded audio data and outputs the data to the speaker of the monitor 960. The recording/playback unit 933 also performs D/A conversion to the decoded video data and outputs the data to the display of the monitor 960.

The recorder control unit 926 reads out the latest EPG data from the EPG data memory 927 based on a user instruction made by the infrared signal received from the remote controller through the receiving unit 921 and supplies the data to the OSD control unit 931. The OSD control unit 931 generates image data corresponding to the inputted EPG data and outputs the data to the display control unit 932. The display control unit 932 outputs the video data inputted from the OSD control unit 931 to the display of the monitor 960 to be displayed thereon. Accordingly, EPG (electronic program guide) is displayed on the display of the monitor 960.

The hard disk recorder 900 can acquire various data such as video data, audio data and EPG data supplied from other devices through networks such as Internet.

The communication unit 935 is controlled by the recorder control unit 926 to acquire coded data of video data, audio data, EPG data and so on transmitted from other devices through the network and supplies the data to the recorder control unit 926. For example, the recorder control unit 926 supplies the acquired coded data of video data or audio data to the recording/playback unit 933 to be stored in the hard disk. At this time, the recorder control unit 926 and the recording/playback unit 933 may perform processing such as re-encoding according to need.

The recorder control unit 926 decodes the acquired coded data of video data or audio data and supplies obtained video data to the display converter 930. The display converter 930 performs processing to the video data supplied from the recorder control unit 926 in the same manner as the video data supplied from the video decoder 925, supplies the data to the monitor 960 through the display control unit 932 and displays the video on the monitor 960.

The recorder control unit 926 also may supply the decoded audio data to the monitor 960 through the D/A converter 934 and output the audio from the speaker in accordance with the image display.

The recorder control unit 926 further decodes the acquired coded data of EPG data and supplies the decoded EPG data to the EPG data memory 927.

In the above description, the hard disk recorder 900 which records video data, audio data and the like in the hard disk has been described, however, any recording medium can be used. For example, recorders applying recording media other than the hard disk, for example, a flash memory, an optical disk and a video tape and so on can apply the above coding system 10 and the decoding system 200 in the same manner as the above hard disk recorder 900.

### [Configuration Example of Camera]

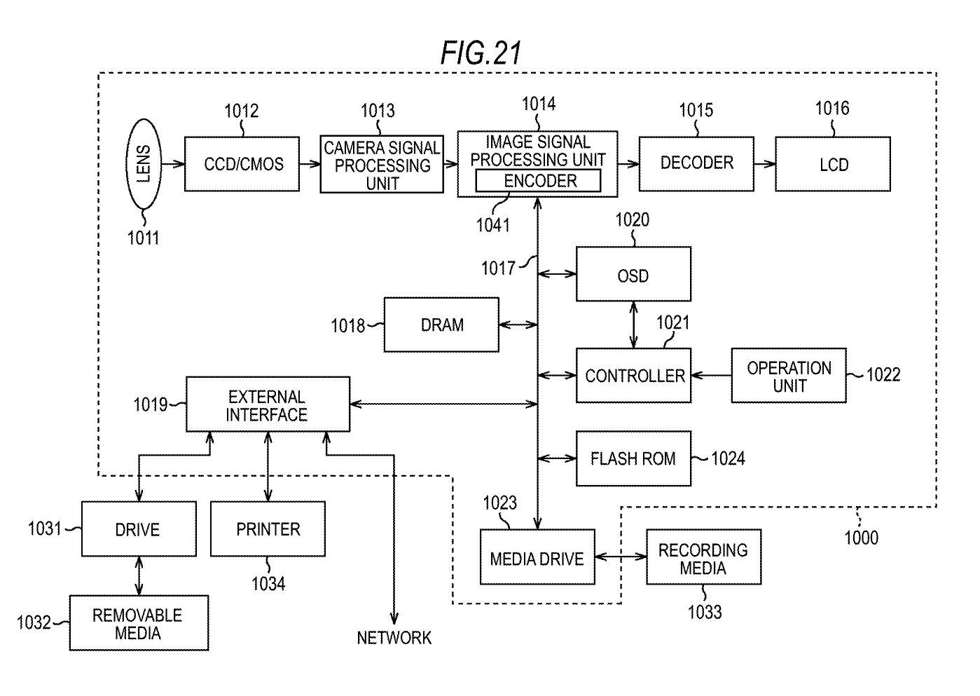

FIG. 21 is a block diagram showing a fundamental configuration example of a camera using the coding system and the decoding system to which the embodiment of the invention is applied.

A camera 1000 of FIG. 21 performs the same processing as the coding system 10 to obtain the bit stream. The camera 1000 also performs the same processing as the decoding system 200 to display stereoscopic images using the bit stream.

A lens block 1011 of the camera 1000 allows light (namely, video of subjects) to be incident on a CCD/CMOS 1012. The CCD/CMOS 1012 is an image sensor using CCD or CMOS, which converts the intensity of received light into electrical signals and supplies the signal to a camera signal processing unit 1013.

The camera signal processing unit 1013 converts the electrical signal supplied from the CCD/CMOS 1012 into color difference signals Y, Cr and Cb to be supplied to an image signal processing unit 1014. The image signal processing unit 1014 performs given image processing to the image signal supplied from the camera signal processing unit 1013 and performs coding complying with the MVC coding method to the image signal at an encoder 1041 under control of a controller 1021.

The camera 1000 performs the same processing as the above video coding device 13 as processing of encoding the image signal generated by imaging in this manner. As a result, it is possible to recognize LR pairs of the taken images and to display the stereoscopic images of the taken images at the time of decoding.

The image signal processing unit 1014 supplies coded data generated by encoding the image signal to a decoder 1015. The image signal processing unit 1014 further acquires display data generated at an onscreen display (OSD) 1020 and supplies the data to the decoder 1015.

In the above processing, the camera signal processing unit 1013 appropriately utilizes a DRAM (Dynamic Random Access Memory) 1018 connected through a bus 1017 to allow the DRAM 1018 to store image data, coded data obtained by encoding the image data and the like according to need.

The decoder 1015 decodes the coded data supplied from the image signal processing unit 1014 and supplies the obtained image data (decoded image data) to an LCD 1016. The decoder 1015 supplies display data supplied from the image signal processing unit 1014 to the LCD 1016. The LCD 1016 appropriately synthesizes images of the decoded image data and images of the display data which have been supplied from the decoder 1015 and displays the synthesis images.

The camera 1000 performs the same processing as the video decoding device 201 as processing of decoding the coded data and displaying the data on the LCD 1016. As a result, for example, it is possible to recognize LR pairs of taken images and to display stereoscopic images of taken images.

The onscreen display 1020 outputs display data such as a menu screen including symbols, text and graphics, or icons to the image signal processing unit 1014 through the bus 1017 under control of the controller 1021.

The controller 1021 executes various processing based on a signal indicating contents instructed by the user using an operation unit 1022 as well as controls the image signal processing unit 1014, the DRAM 1018, an external interface 1019, the onscreen display 1020, a media drive 1023 and the like through the bus 1017. A FLASH ROM 1024 stores programs, data and so on necessary when the controller 1021 executes various processing.

For example, the controller 1021 can encode image data stored in the DRAM 1018 as well as can decode coded data stored in the DRAM 1018 instead of the image signal processing unit 1014 and the decoder 1015. At this time, the controller 1021 may perform coding/decoding processing by the same method as the coding/decoding methods of the image signal processing unit 1014 and the decoder 1015, or may perform coding/decoding processing by a method with which the image signal processing unit 1014 and the decoder 1015 do not comply.

Additionally, for example, when the start of image printing is instructed from the operation unit 1022, the controller 1021 reads out image data from the DRAM 1018 and supplies the data to a printer 1034 connected to the external interface 1019 through the bus 1017 to print images.

Further, for example, when image recording is instructed from the operation unit 1022, the controller 1021 reads out coded data from the DRAM 1018 and supplies the data to a recording media 1033 mounted on the media drive 1023 through the bus 1017 to be stored therein.

The recording media 1033 are arbitrary removable media which can be written and read such as an magnetic disc, an magneto-optic disc, an optical disc or a semiconductor memory. Concerning the recording media 1033, types of the removal media are arbitrary, which includes a tape device, discs or a memory card. A non-contact IC card and the like may be used as a matter of course.

It is also preferable that the media drive 1023 and the recording media 1033 are integrated to configure a non-transportable recording medium which is, for example, an internal hard disk drive, a SSD (Solid State Drive) or the like.

The external interface 1019 is configured by, for example, a USB input/output terminal and is connected to the printer 1034 when performing printing of images. A drive 1031 is connected to the external interface 1019 according to need, on which removable media 1032 such as the magnetic disc, the optical disc and the magneto-optic disc are appropriately mounted, and computer programs read from the media are installed in the FLASH ROM 1024 if necessary.

The external interface 1019 further includes a network interface connected to given networks such as LAN and Internet. The controller 1021 can readout coded data from the DRAM 1018, for example, in accordance with instructions from the operation unit 1022, and can supply the data from the external interface 1019 to other devices connected through networks. The controller 1021 also acquires coded data and image data supplied from other devices through networks through the external interface 1019 and stores the data in the DRAM 1018 or supplies the data to the image signal processing unit 1014.

The image data taken by the camera 1000 may be moving images or still images.

The above coding system 10 and the decoding system 200 can be applied to devices and systems other than the above-described devices.

The present application contains subject matter related to that disclosed in Japanese Priority Patent Application JP 2009-274538 filed in the Japan Patent Office on Dec. 2, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a coding means for encoding image data of multi-view images forming a stereoscopic image to generate a coded stream; and
a transmission means for connecting output time information indicating output time of a decoded result of an image only to coded data of any one of the multi-view images in the coded stream.

2. The image processing apparatus according to claim 1,
wherein the transmission means connects the output time information to coded data of the first image in the coding order of the multi-view images in the coded stream.

3. The image processing apparatus according to claim 1,
wherein the transmission means connects the output time information to coded data of the last image in the coding order of the multi-view images in the coded stream.

4. The image processing apparatus according to claim 1,
wherein the multi-view images are stereo images including a left image observed by a left eye and a right image observed by a right eye,
the transmission means connects the output time information to coded data of the left image in the coded stream.

5. The image processing apparatus according to claim 1,
wherein the multi-view images are stereo images including a left image observed by a left eye and a right image observed by a right eye,
the transmission means connects the output time information to coded data of the right image in the coded stream.

6. The image processing apparatus according to claim 1,
wherein the transmission means connects coding order information indicating the coding order of the multi-view images to the coded stream.

7. An image processing method of an image processing apparatus comprising the steps of:
encoding image data of multi-view images forming a stereoscopic image to generate a coded stream; and
connecting output time information indicating output time of a decoded result of an image only to coded data of any one of the multi-view images in the coded stream.

8. An image processing apparatus comprising:
a receiving means for receiving a coded stream obtained by encoding image data of multi-view images forming a stereoscopic image and output time information indicating output time of a decoded result of an image, which is connected to coded data of any one of the multi-view images in the coded stream;
a decoding means for decoding the coded stream received by the receiving means to generate image data; and
an output means for outputting image data of an image corresponding to the output time information and image data of an image not corresponding to the output time information, which have been generated by the decoding means, as image data of the multi-view images based on the output time information received by the receiving means.

9. The image processing apparatus according to claim 8,
wherein the image corresponding to the output time information is the first image in the coding order in the multi-view images, and
the output means outputs image data of the image corresponding to the output time information and image data of the image not corresponding to the output time information the coding order of which is subsequent to the first image, which have been generated by the decoding means, as image data of the multi-view images based on the output time information.

10. The image processing apparatus according to claim 8,
wherein the image corresponding to the output time information is the last image in the coding order in the multi-view images, and
the output means outputs image data of the image corresponding to the output time information and image data of the image not corresponding to the output time information the coding order of which is previous to the last image, which have been generated by the decoding means, as image data of the multi-view images based on the output time information.

11. The image processing apparatus according to claim 8,
wherein the multi-view images are stereo images including a left image observed by a left eye and a right image observed by a right eye,
the image corresponding to the output time information is the left image and
the output means outputs image data of the left image corresponding to the output time information and image data of the right image not corresponding to the output time information, which have been generated by the decoding means, as image data of the multi-view images based on the output time information.

12. The image processing apparatus according to claim 8,
wherein the multi-view images are stereo images including a left image observed by a left eye and a right image observed by a right eye,
the image corresponding to the output time information is the right image and
the output means outputs image data of the right image corresponding to the output time information and image data of the left image not corresponding to the output time information, which have been generated by the decoding means, as image data of the multi-view images based on the output time information.

13. The image processing apparatus according to claim 8,
wherein the receiving means receives coding order information indicating the coding order of the multi-view images, and
the output means outputs image data of the image corresponding to the output time information and image data of the image not corresponding to the output time information the coding order of which is previous or subsequent to the image corresponding to the information, which have been generated by the decoding means, as image data of the multi-view images based on the coding order indicated by the coding order information.

14. An image processing method of an image processing apparatus comprising the steps of:
receiving a coded stream obtained by encoding image data of multi-view images forming a stereoscopic image and output time information indicating output time of a decoded result of an image, which is connected to coded data of any one of the multi-view images in the coded stream; and
decoding the coded stream received by processing of the receiving step to generate image data; and
outputting image data of an image corresponding to the output time information and image data of an image not corresponding to the output time information, which have been generated by processing of the decoding step, as image data of the multi-view images based on the output time information received by processing of the receiving step.

15. An image processing apparatus comprising:
a coding unit configured to encode image data of multi-view images forming a stereoscopic image to generate a coded stream; and
a transmission unit configured to connect output time information indicating output time of a decoded result of an image only to coded data of any one of the multi-view images in the coded stream.

16. An image processing apparatus comprising:
a receiving unit configured to receive a coded stream obtained by encoding image data of multi-view images forming a stereoscopic image and output time information indicating output time of a decoded result of an image, which is connected to coded data of any one of the multi-view images in the coded stream;
a decoding unit configured to decode the coded stream received by the receiving unit to generate image data; and
an output unit configured to output image data of an image corresponding to the output time information and image data of an image not corresponding to the output time information, which have been generated by the decoding unit, as image data of the multi-view images based on the output time information received by the receiving unit.
